(19) United States
(12) Patent Application Publication
(10) Pub. No.: US 2026/0088745 A1
(43) Pub. Date: Mar. 26, 2026

(54) ROTARY ELECTRIC MACHINE CONTROL DEVICE

(71) Applicant: DENSO CORPORATION, Kariya-city (JP)

(72) Inventors: Tsuyoshi SHINTATE, Kariya-city (JP); Hiroyasu OTAKE, Kariya-city (JP)

(21) Appl. No.: 19/406,548

(22) Filed: Dec. 2, 2025

Related U.S. Application Data
(63) Continuation of application No. PCT/JP2024/020218, filed on Jun. 3, 2024.

(30) Foreign Application Priority Data
Jun. 5, 2023 (JP) 2023-092274

(51) Int. Cl. H02P 23/14; H02P 29/60

(52) U.S. Cl. CPC H02P 23/14; H02P 29/60

(57) ABSTRACT

A rotary electric machine control device is configured to drive a rotary electric machine including multiple motor windings. The rotary electric machine control device includes a main control unit and a sub-control unit provided for respective motor windings and mutually-communicable to perform a coordinated drive control by sharing at least one parameter to perform energization control. Each of the main control unit and the sub-control unit calculates a voltage instruction value of a voltage to be applied to the motor winding based on an electric current detection value and an electric current instruction value, and perform the energization control of the motor winding based on the voltage instruction value. The sub-control unit performs the energization control by using the electric current instruction value that has been transmitted from the main control unit. The main control unit performs the energization control by using the same electric current instruction value.

### CROSS REFERENCE TO RELATED APPLICATION

The present application is a continuation application of International Patent Application No. PCT/JP2024/020218 filed on Jun. 3, 2024, which designated the U.S. and claims the benefit of priority from Japanese Patent Application No. 2023-092274, filed Jun. 5, 2023. The entire disclosures of all of the above applications are incorporated herein by reference.

### TECHNICAL FIELD

The present disclosure generally relates to a rotary electric machine control device.

### BACKGROUND

Conventionally, a rotary electric machine control device to control drive of a rotary electric machine is known.

### SUMMARY

According to an aspect of the present disclosure, a rotary electric machine control device is configured to control drive of a rotary electric machine including a plurality of motor windings. The rotary electric machine control device comprises: at least one of (i) a circuit and (ii) a processor with a memory storing computer program code executable by the processor, the at least one of the circuit and the processor may be configured to cause the rotary electric machine control device to implement: a plurality of control units provided for the respective motor windings and configured to communicate with each other to perform a coordinated drive control for respective systems, each of which including a combination of a motor winding and a control unit corresponding thereto, by sharing at least one parameter for performing energization control, each of the control units configured to calculate a voltage instruction value of a voltage to be applied to the motor winding based on a current detection value and an electric current instruction value of an electric current to be supplied to the motor winding and perform the energization control of the motor winding based on the voltage instruction value. One of the control units is a main control unit, and an other of the control units is a sub-control unit. The sub-control unit may be configured to perform the energization control of the motor winding by using the electric current instruction value transmitted from the main control unit. The main control unit may be configured to perform the energization control of the motor winding by using a same electric current instruction value that has been transmitted to the sub-control unit.

### BRIEF DESCRIPTION OF THE DRAWINGS

The above and other objects, features and advantages of the present disclosure will become more apparent from the following detailed description taken in conjunction with the accompanying drawings. In the drawing:

FIG. 1 shows a schematic diagram of an electric power steering device according to a first embodiment;

FIG. 2 is a cross-sectional view of a drive device according to the first embodiment;

FIG. 3 is a cross-sectional view taken along a line III-III of FIG. 2;

FIG. 4 is a block diagram of a configuration of an ECU according to the first embodiment;

FIG. 5 is a block diagram of an energization control unit of a first control unit;

FIG. 6 is a block diagram of the energization control unit of the first control unit and a second control unit;

FIG. 7 is a time chart explaining a current control process according to a reference example;

FIG. 8 is a time chart explaining the current control process according to the first embodiment;

FIG. 9 is a flowchart explaining the current control process according to the first embodiment;

FIG. 10 is a flowchart explaining the current control process according to a second embodiment;

FIG. 11 is a time chart explaining the current control process according to the second embodiment;

FIG. 12 is another time chart explaining the current control process according to the second embodiment;

FIG. 13 is yet another time chart explaining the current control process according to the second embodiment;

FIG. 14 is a flowchart explaining a setting constant transmission process according to a third embodiment;

FIG. 15 is a time chart of a current detection value and an electric current instruction value;

FIG. 16 is a time chart of a FB control amount of the first control unit for different electric current instruction values;

FIG. 17 is a time chart of the FB control amount of the second control unit for different electric current instruction values;

FIG. 18 is a time chart of a voltage instruction values when a limit value of a sum FB control amount and a difference FB control amount are different;

FIG. 19 is a time chart of electric currents when the limit value of the sum FB control amount and the difference FB control amount are different;

FIG. 20 is a flowchart explaining a FB control amount limitation process according to a fourth embodiment;

FIG. 21 is a time chart of the FB control amount and voltage instruction value according to the fourth embodiment;

FIG. 22 is a time chart of the FB control amount according to the fourth embodiment;

FIG. 23 is another time chart of the FB control amount according to the fourth embodiment;

FIG. 24 is a flowchart explaining an abnormality determination process according to a fifth embodiment;

FIG. 25 is a time chart explaining a transition to an abnormality handling process according to the fifth embodiment;

FIG. 26 is a flowchart explaining the abnormality determination process according to a sixth embodiment;

FIG. 27 is a flowchart explaining an instruction value comparison process in the first control unit according to a seventh embodiment;

FIG. 28 is a flowchart explaining the instruction value comparison process in the second control unit according to the seventh embodiment;

FIG. 29 is a time chart explaining the instruction value comparison process according to the seventh embodiment;

FIG. 30 is another time chart explaining the instruction value comparison process according to the seventh embodiment;

FIG. 31 is a flowchart explaining the instruction value comparison process in the first control unit according to an eighth embodiment;

FIG. 32 is a flowchart explaining the instruction value comparison process in the second control unit according to the eighth embodiment;

FIG. 33 is a time chart explaining the instruction value comparison process according to the eighth embodiment;

FIG. 34 is a flowchart explaining the instruction value comparison process in the first control unit according to a ninth embodiment;

FIG. 35 is a flowchart explaining the instruction value comparison process in the second control unit according to the ninth embodiment;

FIG. 36 is a time chart explaining the instruction value comparison process according to the ninth embodiment;

FIG. 37 is a flowchart explaining a setting constant comparison process in the first control unit according to a tenth embodiment; and

FIG. 38 is a flowchart explaining the setting constant comparison process in the first control unit according to the tenth embodiment.

### DETAILED DESCRIPTION

Hereinafter, examples of the present disclosure will be described.

According to an example, a rotary electric machine control device is to control the drive of a rotary electric machine by coordinating multiple systems. In this example, energization of the first and second systems is controlled based on an instruction value calculated by a first control unit.

When a second control unit performs calculations using instruction values sent by communication from the first control unit, for example, if instruction calculations are not performed in time for a communication timing due to an increased calculation load in the first control unit, and control is performed using different instruction values among the first control unit and the second control unit, a voltage instruction value may increase, resulting in overcurrent.

Further, in the coordinated drive control, when a current sum and a current difference of multiple systems are controlled, the control amount increases if an electric current instruction values differ among the systems. In addition, if the balance between the control amount of the current sum and the current difference is lost in the above-described condition, overcurrent may occur.

According to an example of the present disclosure, a rotary electric machine control device is configured to control drive of a rotary electric machine including a plurality of motor windings. The rotary electric machine control device includes: a plurality of control units provided for the respective motor windings and configured to communicate with each other, each of the control units including an energization control unit configured to (i) calculate a voltage instruction value of a voltage to be applied to the motor winding based on a current detection value and an electric current instruction value of an electric current to be supplied to the motor winding, and (ii) perform energization control of the motor winding based on the voltage instruction value. The control units are configured to perform a coordinated drive control for respective systems each including a combination of the motor winding and the control unit corresponding thereto by sharing at least one parameter for performing the energization control. One of the control units is a main control unit, and an other of the control units is a sub-control unit. The sub-control unit is configured to perform the energization control of the motor winding by using the electric current instruction value transmitted from the main control unit. The main control unit is configured to perform the energization control of the motor winding by using a same electric current instruction value that has been transmitted to the sub-control unit.

In one example, when one control unit is assumed as a main control unit and the other control unit is assumed as a sub-control unit, the sub-control unit uses the electric current instruction value transmitted from the main control unit to control the energization of the motor windings, and the main control unit uses the same electric current instruction value transmitted to the sub-control unit to control the energization of the motor windings.

According to another example, an energization control unit is configured to perform electric current feedback control using a current sum, which is a sum of the current detection value of its own system and the current detection value of an other system, and a current difference, which is a difference between the current detection value of its own system and the current detection value of the other system, limit, in the electric current feedback control, an upper limit and a lower limit of a feedback control amount, which is a result of feedback calculation based on the current sum, and an upper limit and a lower limit of a feedback control amount, which is a result of feedback calculation based on the current difference.

Hereinafter, a rotary electric machine control device according to the present disclosure will be described with reference to the drawings. In the following plural embodiments, substantially same structural configurations are designated with the same reference numerals thereby to simplify the description.

### First Embodiment

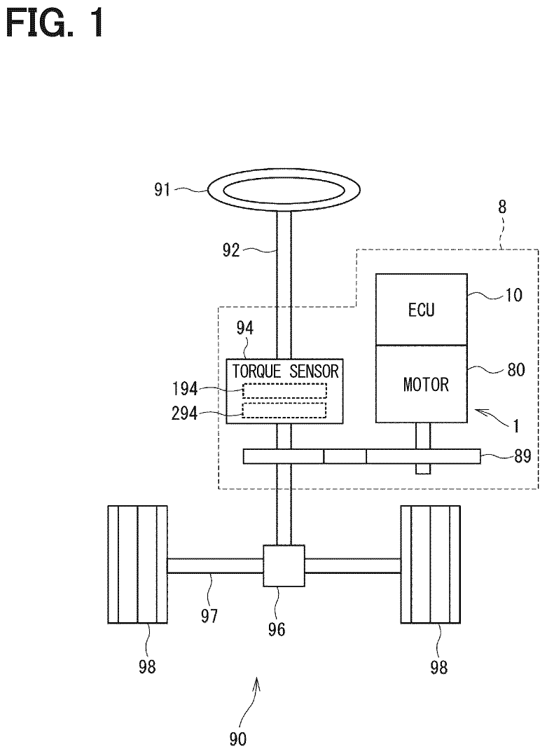

As shown in FIG. 1, an ECU 10 as a rotary electric machine control device is applied together with a motor 80 as a rotary electric machine, for example, to an electric power steering device 8 for assisting the steering operation of a vehicle.

FIG. 1 shows an overall configuration of a steering system 90 including the electric power steering device 8. The steering system 90 includes a steering wheel 91 which is a steering member, a steering shaft 92, a pinion gear 96, a rack shaft 97, a pair of wheels 98, the electric power steering device 8 and the like.

The steering wheel 91 is connected to the steering shaft 92. A torque sensor 94 is provided on the steering shaft 92 to detect a steering torque. The torque sensor 94 has a first torque detector 194 and a second torque detector 294, each of which has a duplex sensor capable of detecting its own faults. The pinion gear 96 is provided at an axial end of the steering shaft 92. The pinion gear 96 meshes with the rack shaft 97. The pair of wheels 98 is connected to both ends of the rack shaft 97 through tie rods or the like.

When a driver rotates the steering wheel 91, the steering shaft 92 connected to the steering wheel 91 rotates. A rotational movement of the steering shaft 92 is converted to a linear movement of the rack shaft 97 by the pinion gear 96. The pair of wheels 98 is steered to an angle corresponding to a displacement amount of the rack shaft 97.

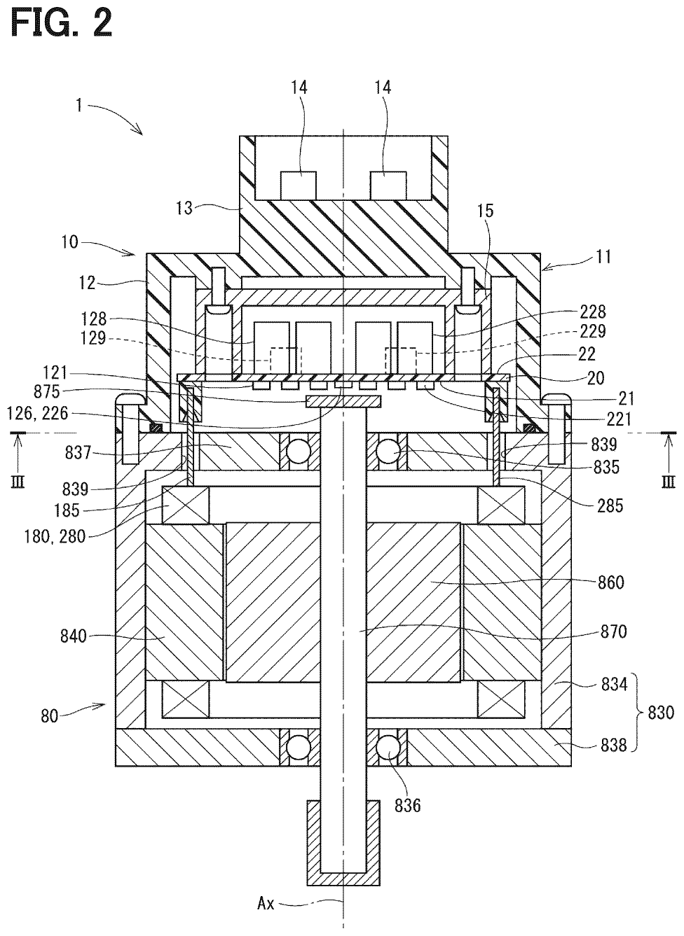

As shown in FIGS. 1 and 2, the electric power steering device 8 is equipped with a drive unit 1 a speed reduction gear 89, which is a power transmission unit, and the like. The drive unit 1 has a motor 80 and the ECU 10. In the drive unit 1, the ECU 10 is integrally provided on one side in an axial direction of the motor 80. That is, the drive unit 1 is provided as a so-called mechanically-electrically integrated type. Alternatively, the motor 80 and the ECU 10 may be disposed separately. The ECU 10 is positioned coaxially with an axis Ax of a shaft 870 on one side opposite to an output shaft of the motor 80. Alternatively, the ECU 10 may be provided on an output shaft side of the motor 80. By adopting the mechanically-electrically integrated type, it may be possible to efficiently position the ECU 10 and the motor 80 in a vehicle having restriction for mounting space.

The speed reduction gear 89 reduces the speed of rotation of the motor 80 and transmits it to the steering shaft 92, which is a drive object. That is, even though the electric power steering device 8 of the present embodiment is a so-called column assist type, it may alternatively be a rack assist type that transmits the rotation of the motor 80 to the rack shaft 97.

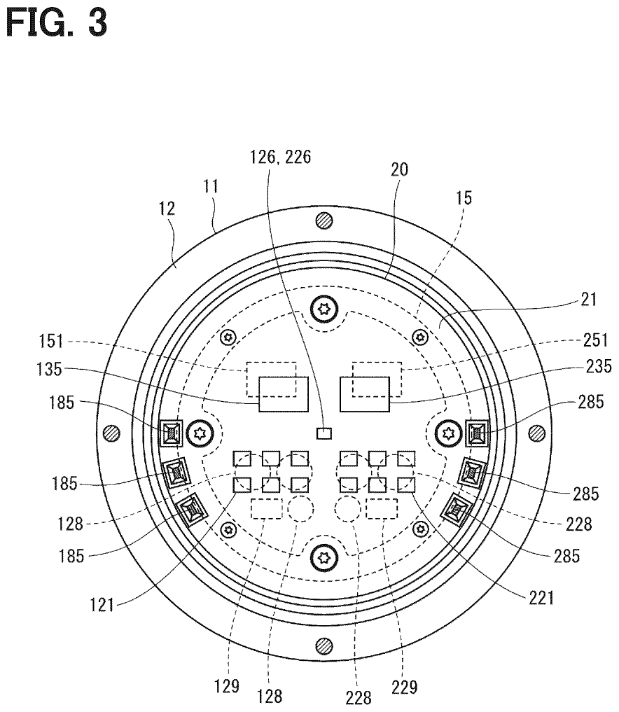

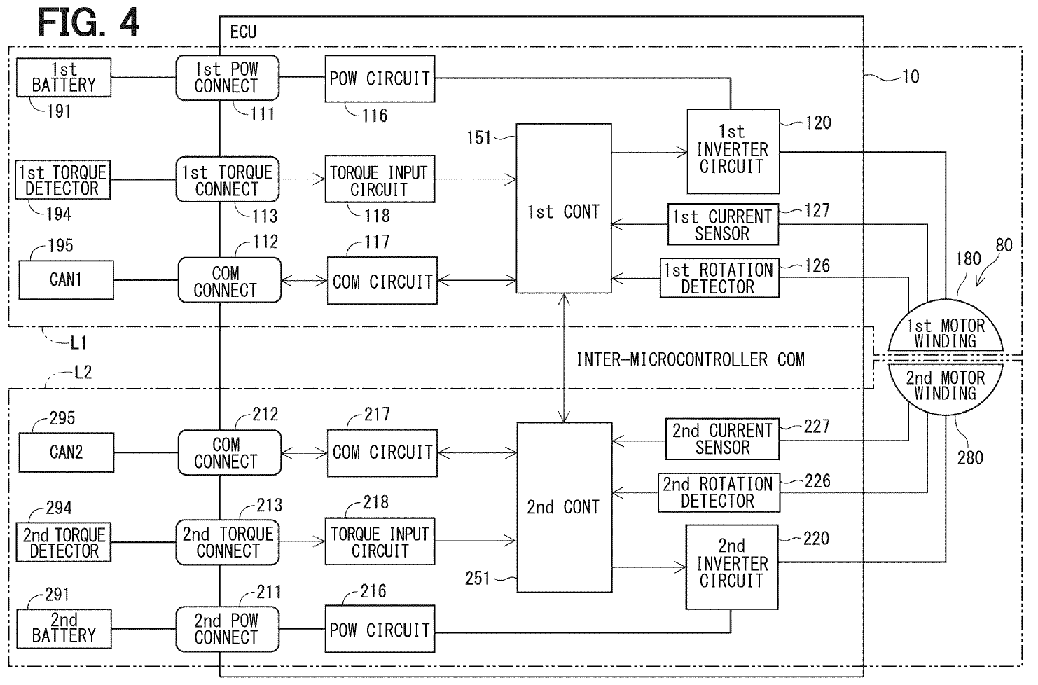

As shown in FIGS. 2 and 3, the motor 80 outputs some or all of the torque required for steering and has two sets of motor windings 180 and 280. The motor 80 is powered by batteries 191 and 291 (see FIG. 4) as a power source, and is driven by controlling the energization of motor windings 180 and 280 to rotate the speed reduction gear 89 forward and reverse. The motor 80 is a 3-phase brushless motor with a stator 840, a rotor 860, a housing 830 that houses them, and the like.

Hereafter, a combination of configurations for the energization control of the first motor winding 180 will be referred to as a first system L1, and a combination of configurations for the energization control of the second motor winding 280 will be referred to as a second system L2, with the configuration for the first system L1 primarily numbered in 100s and the configuration for the second system L2 primarily numbered in 200s. Further, the configuration pertaining to a first control unit 151 of the first system L1 is numbered in 500s, and the configuration pertaining to a second control unit 251 of the second system L2 is numbered in 600s. In the first system L1 and the second system L2, similar or analogous configurations are numbered with the same last two digits, and explanations are omitted as appropriate. Hereinafter, as appropriate, the values for the first system L1 are indicated with a subscript “1” and the values for the second system L2 with a subscript “2”.

The housing 830 includes a bottomed cylindrical case 834, which has a rear frame end 837, and a front frame end 838 provided on an open side of the case 834. The case 834 and the front frame end 838 are tightly fastened to each other by bolts or the like. Lead wire insertion holes 839 are formed in the rear frame end 837.

The stator 840 is fixed to the housing 830 and the motor windings 180 and 280 are wound thereon. Lead wires 185 and 285, which are connected to each phase of the motor windings 180 and 280, are inserted into lead wire insertion holes 839, taken out to an ECU 10 side, and connected to a substrate 20.

The rotor 860 is provided on an inner side of the stator 840 in the radial direction. A magnet is provided outside the stator 840 in the radial direction and is rotatable relative to the stator 840.

The shaft 870 is fitted firmly in the rotor 860 to rotate integrally with the rotor 860. The shaft 870 is rotatably supported by the housing 830 by bearings 835 and 836. An end portion of the shaft 870 on the ECU 10 side protrudes from the housing 830 to the ECU 10 side. A magnet 875 is provided at the axial end of the shaft 870 on the ECU 10 side.

The ECU 10 includes a cover 11, a heat sink 15 fixed to the cover 11, the substrate 20 fixed to the heat sink 15, various electronic components mounted on the substrate 20 and the like.

The cover 11 protects the electronic components from external shocks and prevents dust, water, etc. from entering the interior of the ECU 10. The cover 11 has a cover body 12 and a connector unit 13 formed in one piece. The connector unit 13 may be separate from the cover body 12. The connector unit 13 includes power connectors 111 and 211, vehicle communication connectors 112 and 212, and torque connectors 113 and 213, described below. A connector terminal 14 is connected to the substrate 20. In the present embodiment, the connector unit 13 is provided for each system and has two openings, with those openings provided on an opposite side of the motor 80. The number of openings, orientation, the number of terminals, and the like can be changed as required.

The substrate 20 is a printed circuit board, for example, and is provided to face the rear frame end 837. On the substrate 20, electronic components for two systems are mounted in separate areas for each system. In the present embodiment, electronic components are mounted on a single substrate 20, but they may be mounted separately on multiple substrates. Further, the substrate 20 may be fixed to the motor 80 side (e.g., to the rear frame end 837).

Of the two main surfaces of the substrate 20, one surface on the motor 80 side is a motor face 21 and the other surface opposite to the motor 80 is a cover face 22. As shown in FIG. 3, a switching element 121, which constitutes an inverter circuit 120, a switching element 221, which constitutes an inverter circuit 220, rotation angle detectors 126 and 226, and custom ICs 135 and 235 and the like are mounted on the motor face 21. The rotation angle detectors 126 and 226 are mounted at positions facing the magnet 875 so that changes in the magnetic field caused by the rotation of the magnet 875 can be detected.

On the cover face 22, capacitors 128 and 228, inductors 129 and 229, and microcontrollers and other components implementing the control units 151 and 251 are mounted. In FIG. 3, the microcontrollers that implement the control units 151 and 251 are numbered “151” and “251,” respectively. The capacitors 128 and 228 smoothen electrical power input from the batteries 191 and 291. Further, the capacitors 128 and 228 assist electric power supply to the motor 80 by storing electric charge therein. The capacitors 128 and 228, and the inductors 129 and 229 constitute a filter circuit to reduce noise transmitted from other devices that share the batteries 191 and 291, and to also reduce noise transmitted from the drive unit 1 to other devices that share the batteries 191 and 291. Although omitted in FIG. 3, a power relay, a motor relay, current sensors 127, 227, and the like are also mounted on the motor face 21 or on the cover face 22.

As shown in FIG. 4, the ECU 10 includes the inverter circuits 120, 220, the control units 151, 251, and the like. The ECU 10 is provided with the power connectors 111 and 211, the vehicle communication connectors 112 and 212, and the torque connectors 113 and 213. The first power connector 111 is connected to a first battery 191 and the second power connector 211 is connected to a second battery 291. The power connectors 111 and 211 may be connected to the same battery. The first power connector 111 is connected to a first inverter circuit 120 via a first power circuit 116. The second power connector 211 is connected to a second inverter circuit 220 via a second power circuit 216. Power circuits 116 and 216 include, for example, power relays and the like.

The vehicle communication connector 112 is connected to a vehicle communication network (CAN 1) 195, and the vehicle communication connector 212 is connected to a vehicle communication network (CAN 2) 295. The vehicle communication connectors 112 and 212 are connected to separate vehicle communication networks 195 and 295, respectively, but may be connected to the same vehicle communication network. Regarding the vehicle communication networks 195 and 295 in FIG. 4, CAN (controller area network) is exemplified. However, any other standard such as CAN-FD (CAN with flexible data rate), FlexRay or the like may also be employed. The control units 151 and 251 send and receive various signals to and from the vehicle communication networks 195 and 295 via vehicle communication circuits 117 and 217, respectively.

The torque connectors 113 and 213 are connected to the torque sensor 94. In detail, the first torque connector 113 is connected to the first torque detector 194. The second torque connector 213 is connected to the second torque detector 294.

The first control unit 151 can acquire torque signals pertaining to a steering torque Ts from the first torque detector 194 via the torque connector 113 and a torque sensor input circuit 118. The second control unit 251 can acquire torque signals pertaining to the steering torque Ts from the second torque detector 294 via the torque connector 213 and a torque sensor input circuit 218. In such manner, the control units 151 and 251 can calculate the steering torque Ts based on the torque signals.

The first inverter circuit 120 is a three-phase inverter having six switching elements 121, and converts electric power supplied to the first motor winding 180. The switching element 121 is controlled for on/off operation based on a control signal output from the first control unit 151. The second inverter circuit 220 is a three-phase inverter having six switching elements 221, and converts the electric power supplied to the second motor winding 280. The switching element 221 is controlled for on/off operation based on a control signal output from the second control unit 251.

The first current sensor 127 detects the electric current energized in each phase of the first motor winding 180, and outputs the detection values to the first control unit 151. The second current sensor 227 detects the electric current energized in each phase of the second motor winding 280, and outputs the detection values to the second control unit 251. The first rotation angle detector 126 detects a rotation angle of the motor 80, and outputs the detection value to the first control unit 151. The second rotation angle detector 226 detects a rotation angle of the motor 80, and outputs the detection value to the second control unit 251.

The control units 151 and 251 are mainly composed of a microcontroller or the like, and both have, in their inside, a CPU, a ROM, a RAM, an I/O, and bus lines connecting these configurations, which are not shown in the drawing. Each process in the control units 151 and 251 may be a software process by executing a program stored in advance in a substantial memory device such as ROM (i.e., a readable non-transitory tangible recording medium) by a CPU, or a hardware process by dedicated electronic circuitry. The first control unit 151 and the second control unit 251 can communicate with each other. Hereafter, communication between control units 151 and 251 is referred to as “inter-microcontroller communication.” Any communication method can be used, including serial communication such as SPI and SENT, CAN communication, FlexRay communication, and the like. The same applies to each of the control units in the following embodiments.

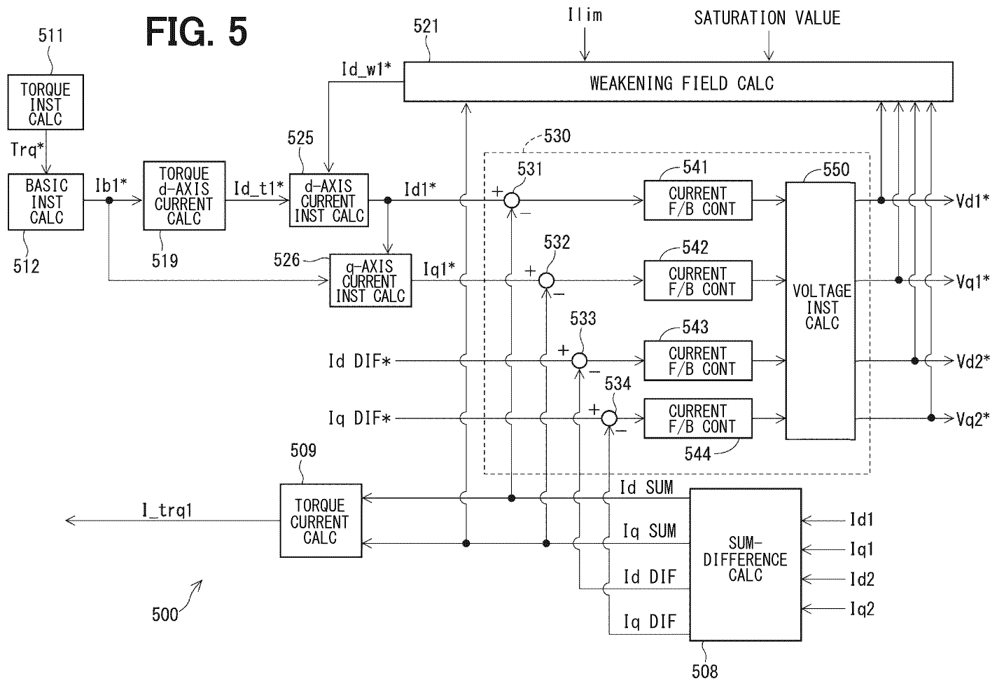

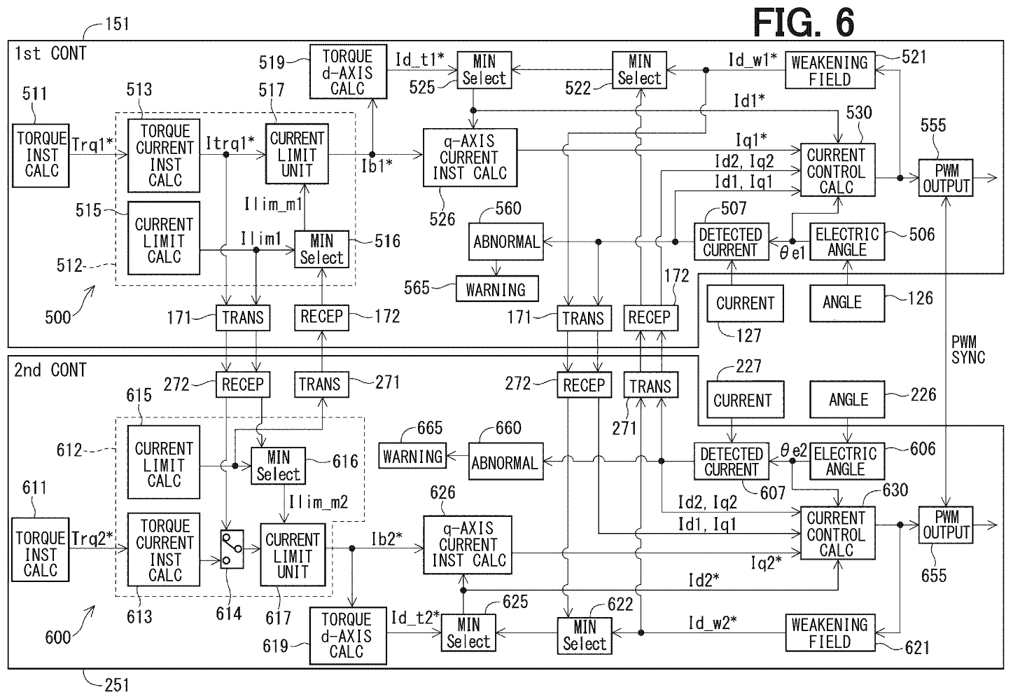

The current control of the present embodiment is shown in FIGS. 5 and 6. In FIGS. 5 and 6, control lines and blocks are partially omitted for simplicity. FIG. 5 shows the first control unit 151, and the second control unit 251 is omitted from the drawing. Further, in FIG. 6, for convenience of description, transmission units 171 and 271 and reception units 172 and 272 are described separately as appropriate. Hereafter, for the points that are similar if the values of the first system L1 and the second system L2 are read accordingly, the explanation pertaining to the second control unit 251, such as d-axis current calculation, will be omitted as appropriate, and the first control unit 151 will be used as an example.

In the present embodiment, the first system L1 is described as a main system and the second system L2 as a subsystem. Here, “main” and “sub” are used for convenience to distinguish which instruction has priority, but the outputs are equivalent. Hereafter, the control in which the first system L1 and the second system L2 are coordinated with the first system L1 provided as the main system and the second system L2 provided as the subsystem is called as “coordinated drive control,” the control in which the two systems are driven without coordinating the first system L1 and the second system L2 is called as “independent drive control,” and the control in which one system L1 or the second system L2 is driven is called as “single system drive control”.

As shown in FIGS. 5 and 6, the first control unit 151 has an energization control unit 500, an abnormality determination unit 560, a warning unit 565, the transmission unit 171, the reception unit 172 and the like. The energization control unit 500 controls the energization of the first motor winding 180, and includes an electric angle calculation unit 506, a detected current calculation unit 507, a torque instruction calculation unit 511, a basic instruction calculation unit 512, a torque d-axis current instruction calculation unit 519, a weakening field calculation unit 521, a weakening field d-axis current instruction mediation unit 522, a d-axis current instruction calculation unit 525, a q-axis current instruction calculation unit 526, a current control calculation unit 530, and a PWM output unit 555.

The second control unit 251 has an energization control unit 600, an abnormality determination unit 660, a warning unit 665, a transmission unit 271, a reception unit 272, and the like. The current control unit 600 controls the energization of the second motor winding 280, and includes an electric angle calculation unit 606, a detected current calculation unit 607, a torque instruction calculation unit 611, a basic instruction calculation unit 612, a torque d-axis current instruction calculation unit 619, a weakening field magnet calculation unit 621, a weakening field d-axis current instruction mediation unit 622, a d-axis current instruction calculation unit 625, a q-axis current instruction calculation unit 626, a current control calculation unit 630, and a PWM output unit 655.

The transmission unit 171 stores a value calculated by the first control unit 151, and transmits the stored value to the second control unit 251 at a communication timing. The reception unit 172 receives a value transmitted from the second control unit 251. The transmission unit 271 stores a value calculated by the second control unit 251, and transmits the stored value to the first control unit 151 at the communication timing. The reception unit 272 receives a value transmitted from the first control unit 151.

An electric angle calculation unit 506 calculates an electric angle θe1 based on the detection value of the rotation angle detector 126. A detected current calculation unit 507 calculates each of phase currents Iu1, Iv1, and Iw2 based on the detection values of the current sensor 127. The detected current calculation unit 507 uses the electric angle θe1 to dq-convert each of the phase currenta Iu1, Iv1, and Iw1, and calculates a d-axis current detection value Id1 and a q-axis current detection value Iq1. Hereafter, when d-axis and q-axis values are described together, they will be referred to as the “dq-axis”. The dq-axis current detection values Id1 and Iq1 are used for current control calculations in the own system, and are also transmitted to the second control unit 250 by inter-microcontroller communication for current control in the other systems.

As shown in FIG. 5, a sum-difference calculation unit 508 acquires the dq-axis current detection values Id1 and Iq1 of the first system L1 and the dq-axis current detection values Id2 and Iq2 of the second system L2. The sum-difference calculation unit 508 calculates a d-axis current sum Id_a, which is the sum of the d-axis current detection values Id1 and Id2; a d-axis current difference Id_s, which is the difference between the d-axis current detection values Id1 and Id2; a q-axis current sum Iq_a, which is the sum of the q-axis current detection values Iq1 and Iq2; and a q-axis current difference Iq_s, which is the difference between the q-axis current detection values Iq1 and Iq2. Calculation. A torque current calculation unit 509 calculates a torque current detection value I_trq1 based on the d-axis current sum Id_a and the q-axis current sum Iq_a. In the present embodiment, the output torque of the motor 80 is monitored by monitoring the torque current detection value I_trq1.

As shown in FIG. 6, a torque instruction calculation unit 511 calculates a torque instruction value Trq1* based on the steering torque, the vehicle speed and the like. A basic instruction calculation unit 512 includes a torque current instruction calculation unit 513, a current limit calculation unit 515, a current limit mediation unit 516, and a current limit unit 517, and calculates a basic electric current instruction value Ib1*. A basic instruction calculation unit 612 includes a torque current instruction calculation unit 613, a switching unit 614, a current limit calculation unit 615, a current limit mediation unit 616, and a current limit unit 617, and calculates a basic electric current instruction value Ib2*.

Torque current instruction calculation units 513 and 613 calculate torque electric current instruction values Itrq1* and Itrq2* based on the torque instruction values Trq1* and Trq2*, for example, by multiplying them by a predetermined factor. The first torque electric current instruction value Itrq1* is transmitted to the second control unit 251.

The switching unit 614 can switch the torque electric current instruction values Itrq1* and Itrq2* used for control. In the present embodiment, the switching unit 614 uses the first torque electric current instruction value Itrq1* during the coordinated drive control, and selects the second torque electric current instruction value Itrq2* during the independent drive control or the single system drive control with the second system L2.

The current limit calculation unit 515 calculates a current limit value Ilim1 for overheat protection, and the like. The current limit value Ilim1 is transmitted to the second control unit 251. Also, the first control unit 151 acquires the current limit value Ilim2 calculated by the second control unit 251.

The current limit mediation unit 516 calculates a post-mediation current limit Ilim_m1 based on the current limit value Ilim1 of its own system and the current limit value Ilim2 of the other system. In the present embodiment, the smaller one of the current limit value Ilim1 of the own system and the current limit value Ilim2 of the other system is used as the post-mediation current limit Ilim_m1 by minimum select.

The current limit unit 517 calculates the basic electric current instruction value Ib1* as a smaller one based on the torque electric current instruction value Itrq1* and the post-mediation current limit value Ilim_m1. The current limiting unit 617 calculates the basic electric current instruction value Ib2* as a smaller one based on the torque electric current instruction value selected by the switching unit 614 and a post-mediation current limit value Ilim_m2.

The torque d-axis current instruction calculation unit 519 calculates a torque d-axis electric current instruction value Id_t1* by map calculation or other means based on the basic electric current instruction value Ib1*.

The weakening field calculation unit 521 calculates a pre-limit weakening field d-axis electric current instruction value Id_wb1* based on the current limit value Ilim1, a saturation value fora maximum applied voltage, a modulation rate of the voltage instruction value and the like. The weakening field calculation unit 521 acquires a q-axis current sum Iq_a from the sum-difference calculation unit 508, and calculates a weakening field d-axis current limit value Id_lim_w1 based on the q-axis current sum Iq_a. The weakening field calculation unit 521 sets the smaller absolute value as a weakening field d-axis electric current instruction value Id_w1* based on the pre-limit weakening field d-axis electric current instruction value Id_wb1* and the weakening field d-axis current limit value Id_lim_w1. The weakening field d-axis electric current instruction value Id_w1* is transmitted to the second control unit 251. Further, the first control unit 151 acquires the weakening field d-axis electric current instruction value Id_w2* calculated by the second control unit 251.

The weakening field d-axis current instruction mediation unit 522 calculates a post-mediation weakening field d-axis electric current instruction value Id_wm1* based on the weakening field d-axis electric current instruction value Id_w1* of its own system and the weakening field d-axis electric current instruction value Id_w2* of the other system. In the present embodiment, the post-mediation weakening field d-axis electric current instruction value Id_wm1* is calculated by minimum select. It should be noted that, when the d-axis current takes a negative value, the larger absolute value is selected by minimum select. The same applies to the minimum select for other d-axis currents. For simplification, the weakening field d-axis current instruction mediation unit 522 is omitted in FIG. 5, and the weakening field d-axis electric current instruction value Id_w1* of the own system is assumed to be input to the d-axis current instruction calculation unit 525.

The d-axis current instruction calculation unit 525 calculates the d-axis electric current instruction value Id1* by minimum select based on the torque d-axis electric current instruction value Id_t1* and the post-mediation weakening field d-axis electric current instruction value Id_wm1*. The q-axis current instruction calculation unit 526 calculates a q-axis electric current instruction value Iq1* based on the basic electric current instruction value Ib1* and the d-axis electric current instruction value Id1*, for example, by map calculation.

The current control calculation unit 530 calculates current sum instruction values Id_a* and Iq_a* and current difference instruction values Id_s* and Iq_s* based on the electric current instruction values Id1*, Iq1*, and the like. As shown in FIG. 5, the current control calculation unit 530 has subtractors 531 to 534, current feedback control units 541 to 544, a voltage instruction calculation unit 550 and the like.

The subtractor 531 subtracts the d-axis current sum Id_a from the d-axis current sum instruction value Id_a*, and calculates a d-axis current sum deviation ΔId_a. The subtractor 532 subtracts the q-axis current sum Iq_a from the q-axis current sum instruction value Iq_a*, and calculates a q-axis current sum deviation ΔIq_a. The subtractor 533 subtracts the d-axis current difference Id_s from the d-axis current difference instruction value Id_s*, and calculates a d-axis current difference deviation ΔId_s. The subtractor 534 subtracts the q-axis current difference Iq_s from the q-axis current difference instruction value Iq_s*, and calculates a q-axis current difference deviation ΔIq_s.

The current feedback control units 541 to 544 respectively calculate sum FB control amounts FBd_a and FBq_a and difference FB control amounts FBd_s and FBq_s by PI calculation, for example, so that the d-axis current sum deviation ΔId_a, the q-axis current sum deviation ΔIq_a, the d-axis current difference deviation ΔId_s, and the q-axis current difference deviation ΔIq_s respectively converge to zero. The voltage instruction calculation unit 550 calculates voltage instruction values Vd1*, Vq1*, Vd2*, and Vq2* based on the FB control amounts FBd_a, FBq_a, FBd_s, and FBq_s. In other words, the coordinated drive control in the present embodiment performs “sum and difference control” to control the sum and difference of the electric currents of the two systems. In such manner, the effects of mutual inductance are cancellable.

The PWM output unit 555 generates PWM signals based on 3-phase voltage instruction values Vu1*, Vv1*, and Vw1*, which are inverse dq transformed from the voltage instruction values Vd1* and Vq1*. The PWM signals are synchronized by, for example, synchronization signals or the like, so that signal timing is aligned across systems. The synchronization signal may be transmitted from one system to the other, or both systems may acquire the synchronization signal from an external source.

The abnormality determination unit 560 determines an abnormality in the current detection values, and the like. When an abnormality is detected, an abnormality handling process is performed. The warning unit 565 warns the driver of the abnormality by means of warning lamps or other means when performing the abnormality handling process. Warnings to the driver are not limited to lighting of warning lamps, but may also be provided as a warning display or audible warning. Details of abnormality determination and the abnormality handling process are explained in the embodiment described below.

In the coordinated drive control, the second system L2 performs the current control using the electric current instruction values transmitted from the first system L1 by inter-microcontroller communication. In detail, the electric current instruction value transmitted from the first system L1 is the first torque electric current instruction value Itrq1*, but for simplicity of explanation, the electric current instruction value commonly used by the control units 151 and 251 during the coordinated drive control is referred to as an electric current instruction value I* in the following as appropriate.

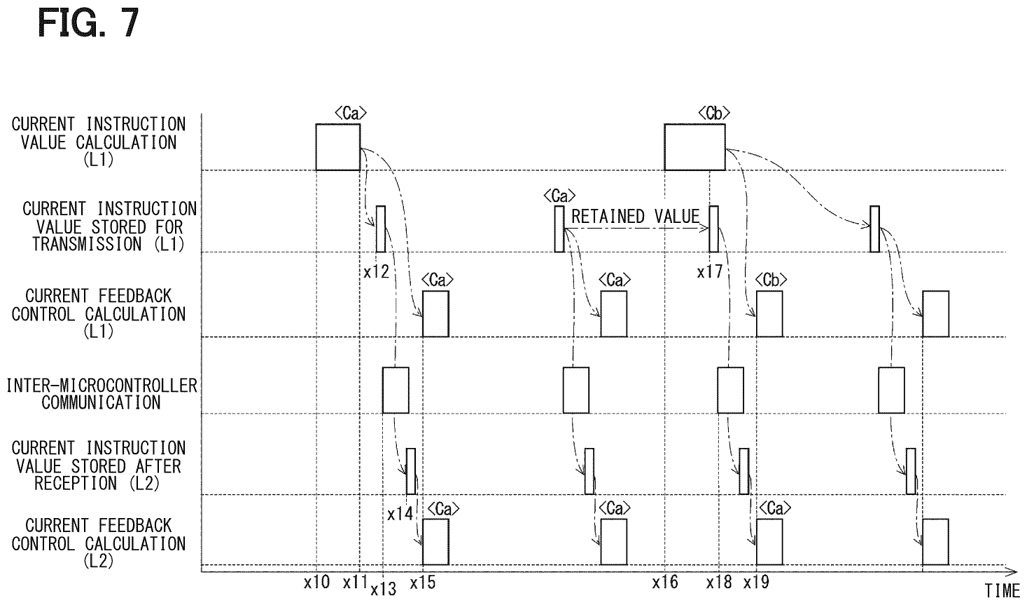

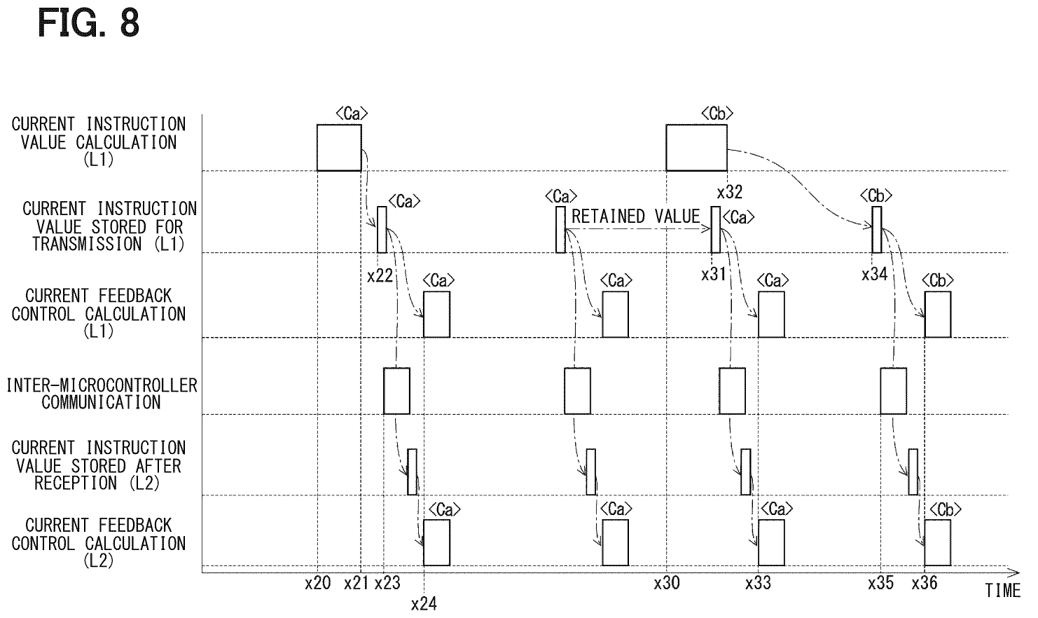

Current control calculations are explained based on the time charts in FIGS. 7 and 8. In FIGS. 7 and 8, the common time axis is set as the horizontal axis, and from the top row, the current instruction calculation in the first control unit 151, the transmitted electric current instruction value storage, the current feedback control in the first control unit 151, the inter-microcontroller communication, the received electric current instruction value storage, and the current feedback control in the second control unit 251 are shown. Hereafter, “feedback” will be referred to as “FB” as appropriate.

In FIG. 7, and the like, the top three rows are the processing in the first control unit 151 and the bottom two rows are the processing in the second control unit 251, with “(L1)” and “(L2)” in the drawing respectively indicating the processing in the first control unit 151 and the processing in the second control unit 251. In addition, the calculated values are described as appropriate, such as “<Ca>,” and the exchange of calculated values is indicated by a single dotted arrow. In FIGS. 7 and 8, the case in which the current FB calculation cycle (e.g., 200 [μs]) is shorter than the instruction calculation cycle (e.g., 400 [μs]) is illustrated.

As shown in FIG. 7, when the value of the electric current instruction value I* calculated by the first control unit 151 at time x10 to time x11 is Ca, the value Ca is stored in the transmission unit 171 as the electric current instruction value I* at time x12. Time x12 is the timing for updating the stored data of the inter-microcontroller communication that starts at time x13. The electric current instruction value I* transmitted from the first control unit 151 to the second control unit 251 at time x13 is stored in the reception unit 272 at time x14. At time x15, the value of the electric current instruction value I* in the current control calculation units 530 and 630 are both Ca, and the current FB calculation is performed using the same value.

If the electric current instruction value I* is not calculated in time for time x17, which is the timing for updating the stored data by inter-microcontroller communication, due to an increase in the calculation load, or the like, regarding the electric current instruction value calculation starting from time x16, the previous value Ca is retained in the transmission unit 171, and at time x18, the value Ca is transmitted as the electric current instruction value I* to the second control unit 251. In the second control unit 251, at time x19, the current FB calculation is performed using the value Ca as the electric current instruction value I*.

As a reference example, if a latest value Cb is used as the electric current instruction value I* for the current FB calculation in the first control unit 151 at time x19, the current FB control with different instruction values will be performed in the control units 151 and 251. If the electric current instruction value I* is different in respective systems, the voltage instruction value may increase, resulting in generation of abnormal electric currents.

Therefore, in order to perform the current FB calculation using the same electric current instruction value I* in the first control unit 151 and the second control unit 252, the first control unit 151 uses the value stored in the transmission unit 171 for the current FB calculation.

As shown in FIG. 8, the value Ca calculated by the current instruction calculation in the first control unit 151 at time x20 to time x21 is stored in the transmission unit 171 at time x22 and is transmitted to the second control unit 251 by inter-microcontroller communication at time x23. Processing on a second control unit 252 side is the same as in FIG. 7. At time x24, the first control unit 151 performs the current FB calculation using the value Ca stored in the transmission unit 171 as the electric current instruction value I*.

In the current instruction calculation starting from time x30, if the electric current instruction value I* is not calculated in time for time x31, which is the stored data update timing for inter-microcontroller communication, the value Ca of the previous update retained in the transmission unit 171 is used by the first control unit 151 at time x33 for the current FB calculation as the electric current instruction value I*. In other words, even though the first control unit 151 has completed the calculation of the electric current instruction value I* at time x32, for the matching of the value used by the second control unit 251, the current FB calculation is performed using the value Ca, which is the previous value stored in the transmission unit 171, instead of using the value Cb, which has been calculated at time x32.

At time x34, which is the next data update timing, the value Cb that was calculated at time x32 is stored in the transmission unit 171 as the electric current instruction value I*, and is transmitted to the second control unit 251 at time x35. At time x36, the control units 151 and 251 both perform the current FB control using the value Cb as the electric current instruction value I*.

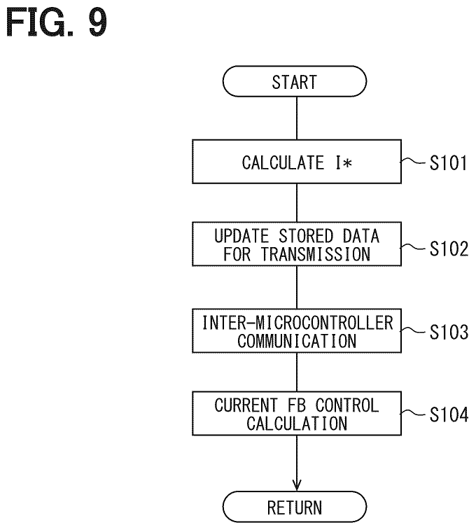

The current control process in the present embodiment is described based on the flowchart in FIG. 9. This process is performed in the first control unit 151, which is the main control unit. Hereinafter, “step” in step S101 is omitted, and is simply referred to as a symbol “S”.

In S101, the first control unit 151 calculates the electric current instruction value I*. In S102, the first control unit 151 updates data in the transmission unit 171 at a predetermined update timing. Here, if the current instruction calculation has not been complete, a previous value is retained. In S103, the first control unit 151 transmits the data stored in the transmission unit 171 to the second control unit 251 by inter-microcontroller communication. In S104, the first control unit 151 performs a current FB control calculation using the electric current instruction value I* stored in the transmission unit 171.

In the present embodiment, the first control unit 151 performs the current FB calculation using the values stored in the transmission unit 171 so that the same electric current instruction value I* is used in the first system L1 and the second system L2. As a result, even when the electric current instruction value I* is not calculated in time for the inter-microcontroller communication, current feedback calculation using the same value is performable in the control units 151 and 251.

As explained above, the ECU 10 controls the drive of the motor 80 having multiple sets of motor windings 180 and 280, and includes multiple control units 151 and 251. The control units 151 and 251 have energization control units 500 and 600, which are provided for each motor winding 180 and 280 and can communicate with each other. The energization control units 500 and 600 calculate voltage instruction values to be applied to the motor windings 180 and 280 based on the current detection values and the electric current instruction values of the current energized in the motor windings 180 and 280, and control the energization of the motor windings 180 and 280 based on the voltage instruction values.

The ECU 10 can perform the coordinated drive control, in which the combinations of the motor windings 180 and 280 and the corresponding control units 151 and 251 respectively serve as a system, and at least one parameter is shared among the systems to control energization. The parameters include the electric current instruction values, the current detection values, and the like. It may include instruction values and detection values pertaining to other than current. In detail, the current detection values Id1, Iq1, Id2, Iq2, and the torque electric current instruction value Itrq1*, and the like are shared in the coordinated drive control in the present embodiment.

Assuming that one control unit 151 is the main control unit and the other control unit 251 is the sub-control unit, the second control unit 251 uses the electric current instruction value I* transmitted from the first control unit 151 to control the energization of the motor winding 280. The first control unit 151 controls the energization of the motor winding 180 using the same electric current instruction value I* that was transmitted to the second control unit 251. By using the same electric current instruction value I* in the control units 151 and 251, abnormal currents due to deviation of instruction values between systems are preventable.

The first control unit 151 includes the transmission unit 171 that can store the electric current instruction value I* to be transmitted to the second control unit 251, and uses the electric current instruction value I* stored in the transmission unit 171 to control the energization of the motor winding 180. In such manner, the first control unit 151 performs the current FB control calculation using the same value transmitted to the second control unit 251, even when the calculation of the electric current instruction value I* is not complete in time for inter-microcontroller communication due to, for example, calculation load or the like.

### Second Embodiment

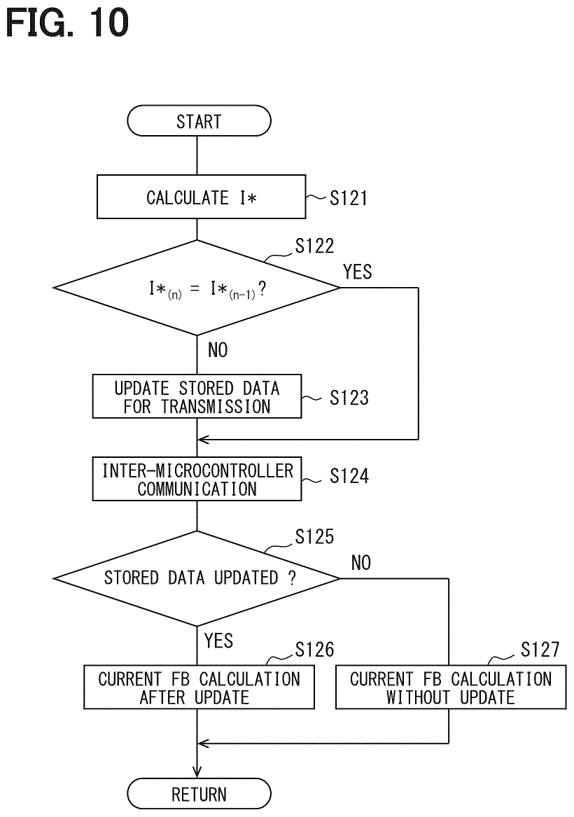

The second embodiment is shown in FIGS. 10 through 13. The current control process in the present embodiment is described based on the flowchart in FIG. 10. Hereafter, the calculation timing is indicated by subscripts (n), (n−1), and the like, as appropriate. In S121, the first control unit 151 calculates the electric current instruction value I* as in S101.

In S122, the first control unit 151 determines whether a current value I*(n) to be stored in the transmission unit 171 is different from a previous value I*(n−1). When it is determined that the current value I*(n) is equal to the previous value I*(n−1) (S122: NO), S123 is skipped and the value in the transmission unit 171 is not updated. When it is determined that the current value I*(n) is different from the previous value I*(n−1) (S122: YES), the process proceeds to S123 to update the data in the transmission unit 171 at the specified update timing. In S124, the control unit 151 transmits the data stored in the transmission unit 171 to the second control unit 251 by inter-microcontroller communication.

In S125, the first control unit 151 determines whether the electric current instruction value I* stored in the transmission unit 171 has been updated. When it is determined that the electric current instruction value I* in the transmission unit 171 is updated (S125: YES), the process proceeds to S126 to update the electric current instruction value I* and perform the current FB control calculation. When it is determined that the electric current instruction value I* in the transmission unit 171 has not been updated (S124: NO), the process proceeds to S127 and the current FB control calculation is performed without updating an electric current instruction value I1*.

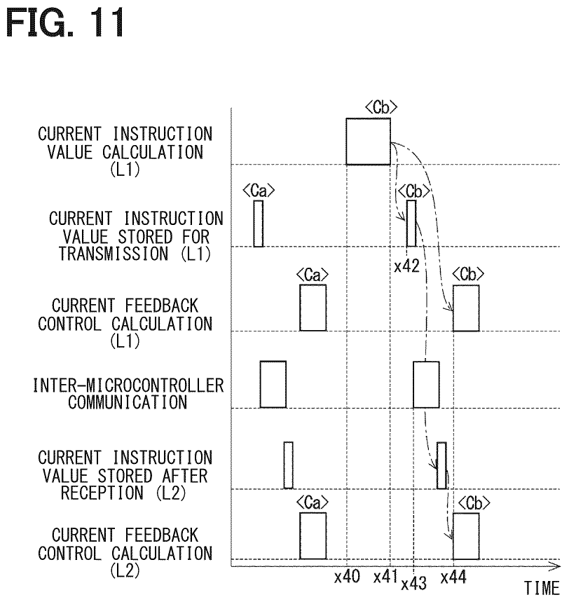

The time charts explaining the current control process are shown in FIGS. 11 through 13. As shown in FIG. 11, since a value of the electric current instruction value I* calculated by the first control unit 151 at time x40 to time x41 is Cb, which is different from the value Ca stored in the transmission unit 171, the value Cb is stored in the transmission unit 171 at time x42, i.e., at the timing for updating the stored data of the inter-microcontroller communication.

At time x43, the electric current instruction value I* is transmitted to the second control unit 251 via the inter-microcontroller communication. At time x44, the first control unit 151 performs the current FB calculation using the value Cb, because the electric current instruction value I* stored in the transmission unit 171 is updated to the value Cb. As a result, at time x44, the current FB control calculation using the same value of Cb is performed in the control units 151 and 251.

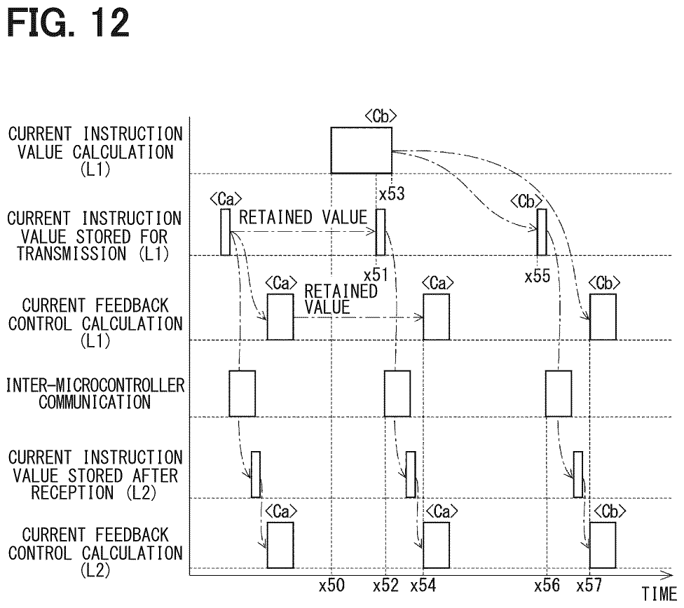

As shown in FIG. 12, in the current instruction calculation from time x50, when the electric current instruction value I* is not calculated in time for time x51, i.e., before the stored data update timing of the inter-microcontroller communication, the data in the transmission unit 171 is not updated and the value Ca is retained and transmitted to the second control unit 251 at time x52. In the second control unit 251, at time x54, the current FB control calculation is performed using the value Ca as the electric current instruction value I*. Also, at time x54, the first control unit 151 does not update the instruction value used for the current FB control calculation, because the data in the transmission unit 171 has not been updated, and the current FB control calculation is performed using the value Ca as the electric current instruction value I*. In other words, when the value stored in the transmission unit 171 is not updated, the electric current instruction value I* used for the current FB control calculation is not updated.

At time x55, which is the subsequent data update timing after time x51, the electric current instruction value I* stored in the transmission unit 171 is updated to the value Cb that has been calculated at time x53, and the updated electric current instruction value I* is transmitted to the second control unit 251 at time x56. At time x57, the second control unit 252 performs the current FB calculation using the value Cb as the electric current instruction value I*. Also, the first control unit 151 updates the electric current instruction value I* to the value Cb and performs the current FB control calculation, because the data in the transmission unit 171 has been updated.

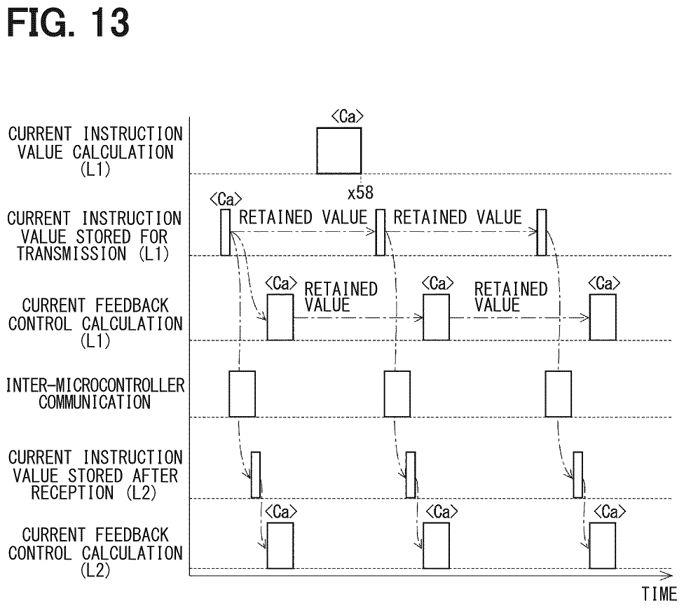

As shown in FIG. 13, when a value of the electric current instruction value I*, calculation of which has been complete at time x58, is the same as the value Ca stored in the transmission unit 171, the value stored in the transmission unit 171 is not updated. The control units 151 and 251 continue the calculation using the value Ca as the electric current instruction value I* until the next calculation of the electric current instruction value I*.

In the present embodiment, the first control unit 151 determines an update status of the electric current instruction value I* stored in the transmission unit 171, and when the value has been updated, the first control unit 151 updates the electric current instruction value I* used for the current FB control calculation. When the electric current instruction value I* stored in the transmission unit 171 has not been updated, the electric current instruction value I* used for the current FB calculation is not updated, and the current FB calculation is performed with the previous value. In such manner, the current FB calculations using the same values at the control units 151 and 251 are performable.

When the electric current instruction value I* stored in the transmission unit 171 has not been updated, the first control unit 151 retains the previous value as the electric current instruction value, and controls the energization of the motor winding 180. In such manner, the occurrence of abnormal currents due to deviations in the instruction values between different systems is preventable, because if the electric current instruction value I* is not calculated in time for the inter-microcontroller communication due to, for example, a calculation load, the current FB control calculation is performed in the first control unit 151 with the previous value without updating the electric current instruction value I*. The second embodiment also achieves the same advantages as the embodiment described above.

### Third Embodiment

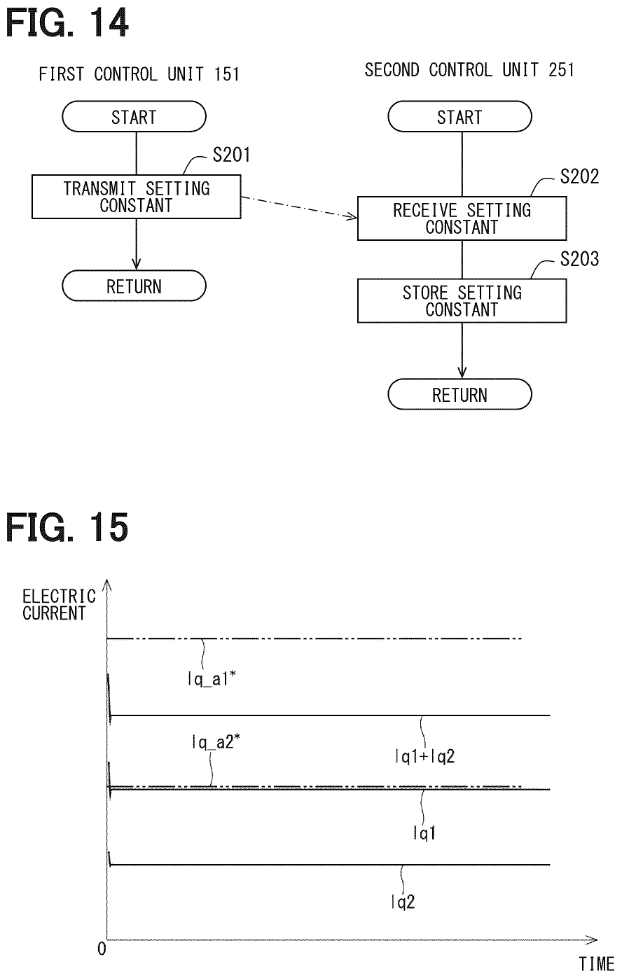

FIG. 14 show the third embodiment. In the above-described embodiment, the current FB control is performed by the control units 151 and 251 using the same value as the electric current instruction value I*. Even if the electric current instruction value I* is the same, when setting constants used for the current FB control are different, the voltage instruction value as a result of the current FB control calculation may become different, and the abnormal current may be generated.

Therefore, in the present embodiment, all the setting constants are possessed by the first control unit 151, and the second control unit 251 performs the current control calculation using the setting constants transmitted from the first control unit 151. Setting constants include, for example, the current limit value, a PI gain, an abnormality determination threshold value, and the like. Note that, in configuration, the second control unit may possess a setting constant, and the setting constant may be transmitted from the second control unit 251 to the first control unit 151.

The setting constant transmission process of the present embodiment is described based on the flowchart in FIG. 14. The setting constant transmission process is performed, for example, during an initial check when the ECU 10 is started, but may be performed at any timing other than the initial check. The same applies to the tenth embodiment.

In S201, the first control unit 151 transmits the setting constants to the second control unit 251. In S202, the second control unit 251 receives the setting constants from the first control unit 151. In S203, the second control unit 251 stores the received setting constants in a memory unit not shown.

In the present embodiment, one control unit 151 transmits the setting constant, which is the constant used in the current control calculation, to the other control unit 251. In other words, in the present embodiment, the setting constant is stored in only one control unit 151, and the setting constant is shared with the other control units 251. In such manner, the same setting constants are used in the control units 151 and 251 for the current control calculations, thus preventing deviations in calculated values due to differences in the setting constants. The third embodiment also achieves the same advantages as the embodiments described above.

### Fourth Embodiment

The fourth embodiment is shown in FIGS. 15 through 23. In the above-described embodiments, the electric current instruction value I* is shared among the control units 151 and 251. In the present embodiment, the electric current instruction value I* is different in the control units 151 and 251, which is explained in the following description.

First, the current FB control calculation is explained using the q-axis current as an example. Assuming that the q-axis current detection value of the first system L1 is Iq1, the q-axis current detection value of the second system L2 is Iq2, the q-axis current sum Iq_a is represented by an equation (1), and the q-axis current difference Iq_s is represented by an equation (2). When the current difference instruction value is set to 0 and the current detection value is stable, the current sum instruction value is equal to the current sum. Also, assuming the equations (1) and (2), the current detection values Iq1 and Iq2 are represented by equations (3) and (4) from the current sum and the current difference.

$$Iq\_a = Iq 1 + Iq 2 \qquad ( 1 )$$

$$Iq\_s = Iq 1 - Iq 2 \qquad ( 2 )$$

$$Iq 1 = ( Iq\_a + Iq\_s ) / 2 \qquad ( 3 )$$

$$Iq 2 = ( Iq\_a - Iq\_s ) / 2 \qquad ( 4 )$$

Assuming that the current sum instruction value of the first system L1 is x and the current sum instruction value of the second system L2 is y, equations (5) to (7) are made, and FB control amounts FBq_a1, FBq_a2, FBq_s1 and FBq_s2 all have the same slope. That is, in the first system L1, the sum FB control amount FBq_a1 and the difference FB control amount FBq_s1 increase by the same amount in the opposite directions, and, in the second system L2, the sum FB control amount FBq_a2 and the difference FB control amount FBq_s2 increase by the same amount in the same direction. Further, when the sum FB control amount and the difference FB control amount change similarly, the voltage instruction value does not change.

$$Current sum instruction value of the first system - Current sum = {Iq\_a1}^{*} - Iq\_a = x - ( x + y ) / 2 = ( x - y ) / 2 \qquad ( 5 )$$

$$Current sum instruction value of the second system - Current sum = {Iq\_a2}^{*} - Iq\_a = y - ( x + y ) / 2 = - ( x - y ) / 2 \qquad ( 6 )$$

$$Current difference instruction value - Current difference = {Iq\_s1}^{*} - Iq\_s = Iq\_s2 * - Iq\_s = 0 - ( x - y ) / 2 = - ( x - y ) / 2 \qquad ( 7 )$$

The voltage instruction value Vq1* of the first system L1 is represented by an equation (8), and the voltage instruction value Vq2* of the second system L2 is represented by an equation (9).

$$Vq {1}^{*} = ( FBq\_a1 + FBq\_s1 ) / 2 \qquad ( 8 )$$

$$Vq {2}^{*} = ( FBq\_a2 + FBq\_s2 ) / 2 \qquad ( 9 )$$

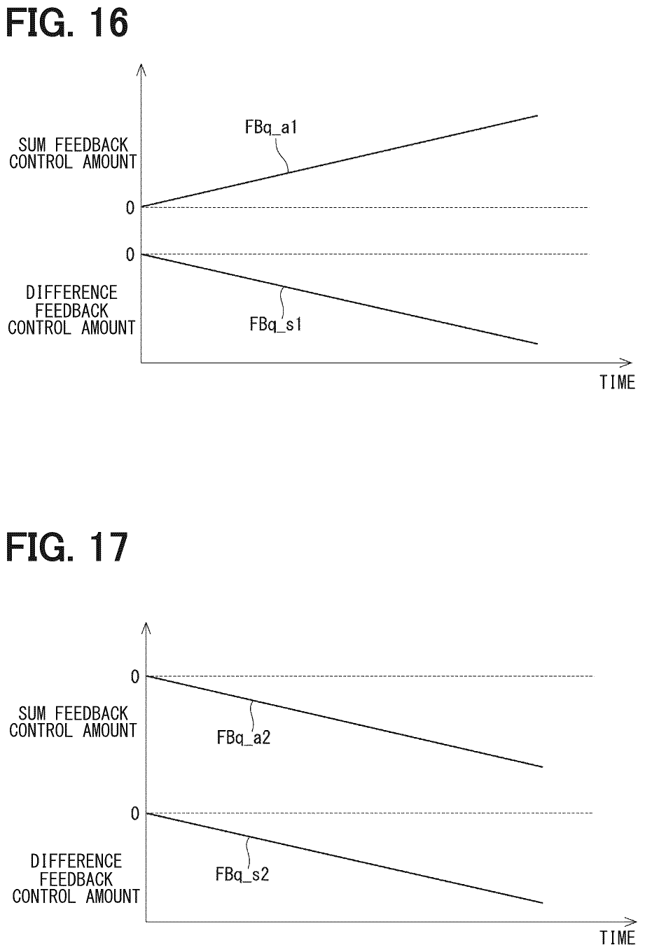

FIGS. 15 through 17 all have a horizontal axis as time, with which FIG. 15 shows the electric current instruction value and the current detection value, FIG. 16 shows the sum FB control amount and the difference FB control amount of the first control unit 151, and FIG. 17 shows the sum FB control amount and the difference FB control amount of the second control unit 251, respectively. As shown in FIG. 15, the current sum instruction value Iq_a1* and the current detection value Iq1 of the first control unit 151, and the current sum instruction value Iq_a2* and the current detection value Iq2 of the second control unit 251 are assumed to be different from each other.

As shown in FIG. 16, in the first control unit 151, since the q-axis current sum Iq_a which is a detection value is smaller than the current sum instruction value Iq_a1*, the sum FB control amount FBq_a1 is calculated for increasing the current sum. As shown in FIG. 17, in the second control unit 251, since the q-axis current sum Iq_a is larger than the current sum instruction value Iq_a2*, the sum FB control amount FBq_a2 is calculated for reducing the current sum. Further, as shown in FIGS. 16 and 17, since there is a difference in the current detection values Iq1 and Iq2, the difference FB control amounts FBq_s1 and FBq_s2 are calculated on the side of reducing the current difference.

In the present embodiment, guards are applied to the upper and lower limits of the FB control amount to prevent control overflow in the current control calculation units 530 and 630. When the limit value of the sum FB control amount is A_lim and the limit value of the difference FB control amount is S_lim, the sum limit value A_lim is set to be larger than the difference limit value S_lim, for example, to set respectively different values to the sum limit value A_lim and to the difference limit value S_lim.

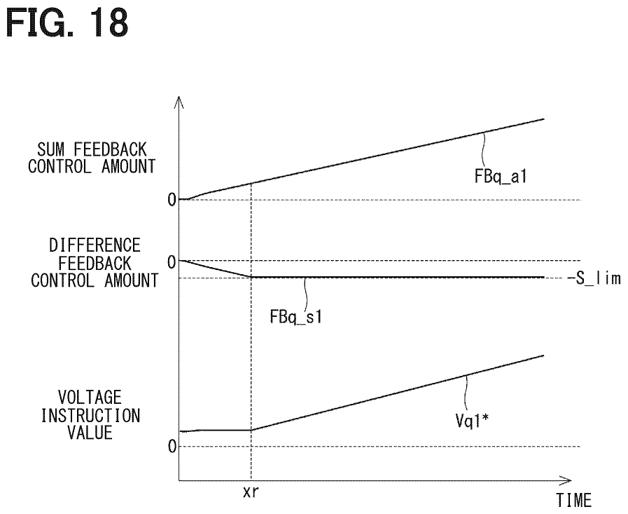

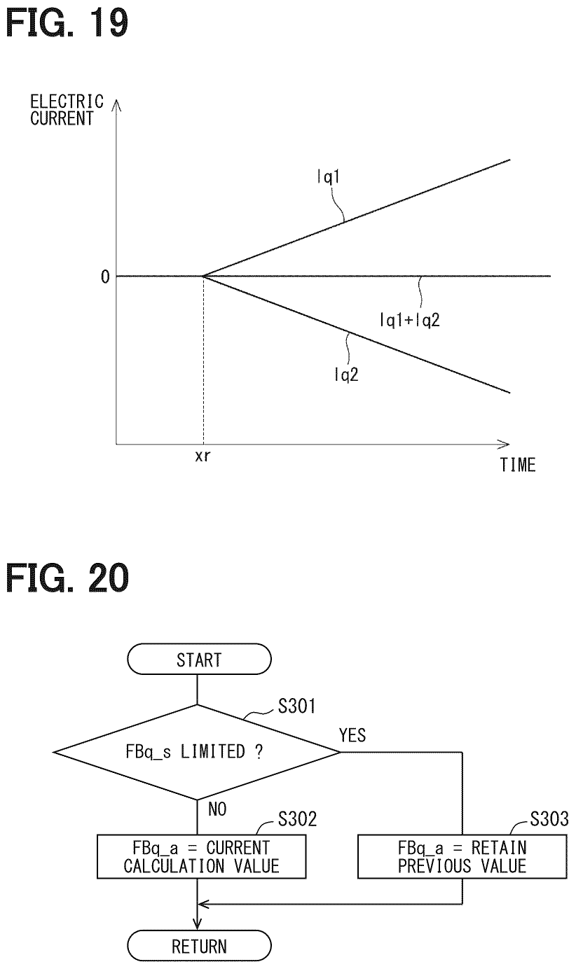

FIG. 18 shows the values pertaining to the q-axis current of the first system L1, which are from the top row, the sum FB control amount FBq_a1, the difference FB control amount FBq_s1, and the voltage instruction value Vq1*. In this example, the limit value A_lim of the sum (not shown in FIG. 18) is different from the limit S_lim of the difference, which is |S_lim|<|A_lim|. At time xr, when the FB control amount FBq_s1 of the difference becomes the limit value-S_lim, the following equation holds true: FBq_s1=−S_lim. On the other hand, since the sum FB control amount FBq_a1<A_lim, the voltage instruction value Vq1* increases as the sum FB control amount FBq_a1 increases. As shown in FIG. 19, even when the current sum is constant, if the current detection values Iq1 and Iq2 increase as the voltage instruction values Vq1* and Vq2* increase, an overcurrent may occur.

Therefore, in the present embodiment, when one of the sum FB control amount FBq_a or the difference FB control amount FBq_s is limited by the limit value, the other retains the previous value. The FB control amount limitation process in the present embodiment is explained based on the flowchart in FIG. 20. In FIG. 20, the sum limit value A_lim is assumed to be greater than the difference limit value S_lim.

In S301, the current control calculation units 530 and 630 determine whether the differential FB control amount FBq_s is limited by the differential limit value S_lim. When it is determined that the difference FB control amount FBq_s is not limited by the difference limit value S_lim (S301: NO), the process proceeds to S302 and uses the current calculation value as the sum FB control amount FBq_a. When it is determined that the difference FB control amount FBq_s is limited by the difference limit value S_lim (S301: YES), the process proceeds to S303 and retains the previous value as the sum FB control amount FBq_a.

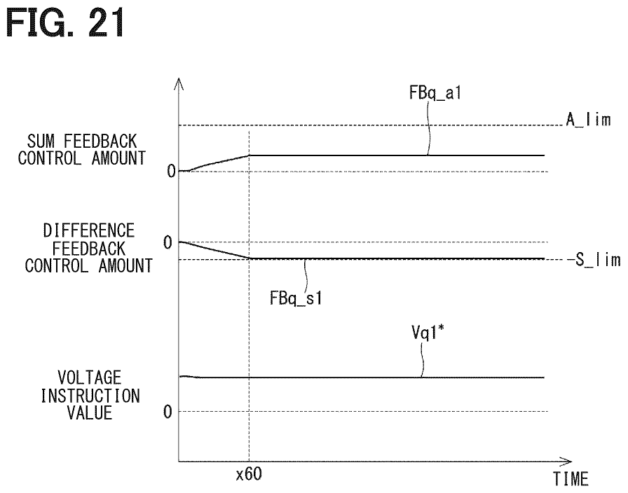

In FIG. 21, taking the first system L1 as an example, the common time axis is the horizontal axis, and the graphs from the top row show, the sum FB control amount FBq_a1, the difference FB control amount FBq_s1, and the voltage instruction value Vq1*. As shown in FIG. 21, if |S_lim|<|A_lim| and the difference FB control amount FBq_s1 is limited by the difference limit-S_lim at time x60, the sum FB control amount FBq_a1 retains its previous value. In such manner, overcurrent are preventable because the voltage instruction value Vq1* is maintained.

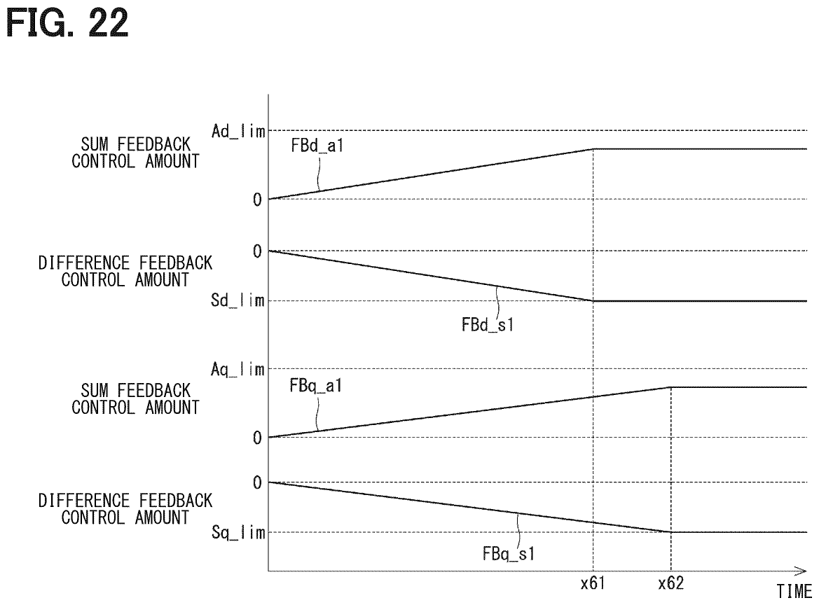

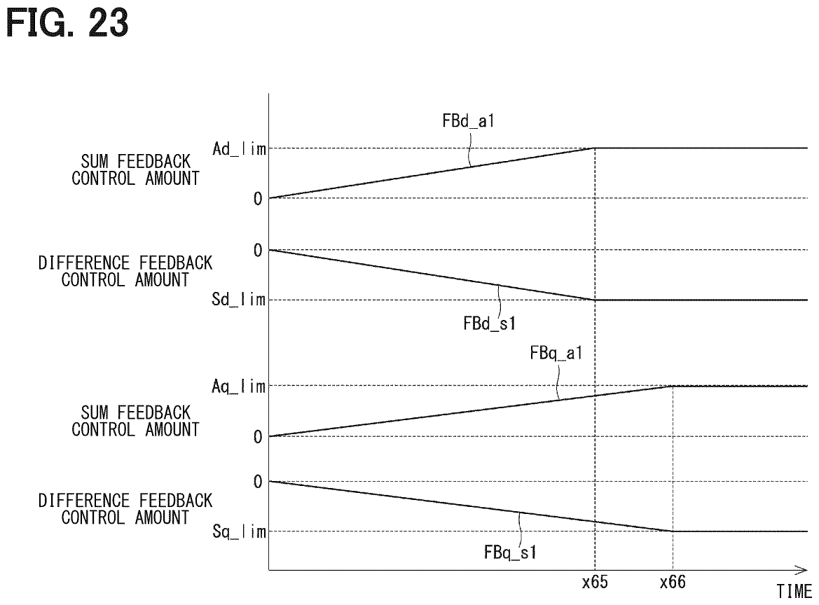

Note that the limit values may be same values or different values respectively regarding the d-axis and the q-axis, i.e., as long as the sum and the difference are matched regarding the d-axis and for the q-axis. In FIGS. 22 and 23, taking the first system L1 as an example, the common time axis is the horizontal axis, and the sum FB control amounts FBd_a1 and the difference FB control amount FBd_s1 of the d-axis, and the sum FB control amount FBq_a1 and the difference FB control amount FBq_s1 of the q-axis are shown from the top row in order. Further, it is assumed that the sum limit value for the d-axis is Ad_lim, the difference limit value for the d-axis is Sd_lim, the sum limit value for the q-axis is Aq_lim, and the difference limit value for the q-axis is Sq_lim.

In the example of FIG. 22, the difference limit value for the d-axis, Sd_lim, is different from the difference limit value for the q-axis, Sq_lim, where Sd_lim<Sq_lim. At time x61, the difference FB control amount FBd_s1 of the d-axis is limited by the limit value Sd_lim, thereby the sum FB control amount FBd_a1 retains its previous value. Also, at time x62, the differential FB control amount FBq_s1 of the q-axis is limited by the limit value Sq_lim, thereby the sum FB control amount FBq_a1 retains its previous value.

Further, the slope of the FB control amounts is the same, the overcurrent can also be prevented by setting the sum limit value Ad_limit and the difference limit value Sd_limit for the d-axis and the sum limit value Aq_limit value and the difference limit value Sq_limit for the q-axis to the same value, respectively, as shown in FIG. 23. In the example in FIG. 23, at time x65, both of the sum FB control amount FBd_a1 and the difference FBs_s1 of the d-axis are limited by the limit value. Also, at time x66, both of the sum FB control amount FBq_a1 and the difference FB control amount FBq_s1 of the q-axis are limited by the limit value.

In the present embodiment, the energization control units 500 and 600 limit the upper and lower limits of (a) the sum FB control amount FB_a, which is the result of feedback calculation based on the current sum, and (b) the difference FB_s, which is the result of feedback calculation based on the current difference, in the current feedback control using the current sum and the current difference between the current detection value of the own system and that of the other system. In detail, the upper and lower limits are limited so that the sum FB control amount FB_a and the difference FB control amount FB_s are limited simultaneously during the coordinated drive control. Here, “simultaneously” means that an error is allowed to an extent that does not break the balance of the two amounts, which may lead to a generation of high electric current. In such manner, control overflow is preventable.

When one of the sum FB control amount FB_a or the difference FB control amount FB_s is limited by the limit value, the other of the sum FB control amount FB_a or the difference FB control amount FB_s retains the previous value. Thus, even when the sum limit value A_lim and the difference limit value S_lim are set to different values, the sum FB control amount, FB_a, and the difference FB control amount, FB_s, can be limited simultaneously during the coordinated drive control, thereby preventing overcurrent.

Further, the sum limit value A_lim, which limits the upper and lower limits of the sum FB control amount FB_a, and the difference limit value S_lim, which limits the upper and lower limits of the difference FB control amount FB_s, may be the same. In such manner, the sum FB control amount and the difference FB control amount are prevented from losing balance, thereby preventing overcurrent. The fourth embodiment also achieves the same advantages as the embodiments described above.

### Fifth Embodiment

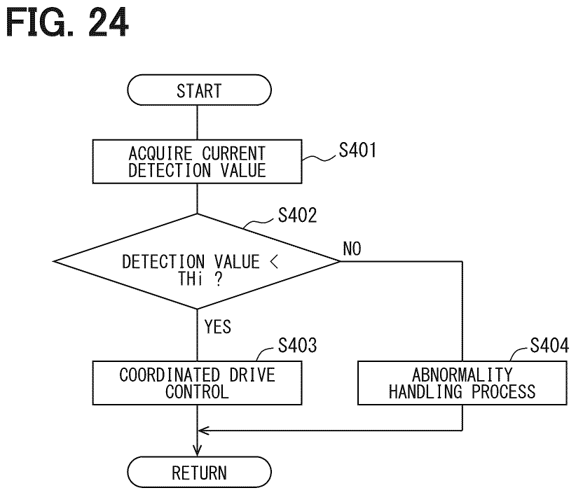

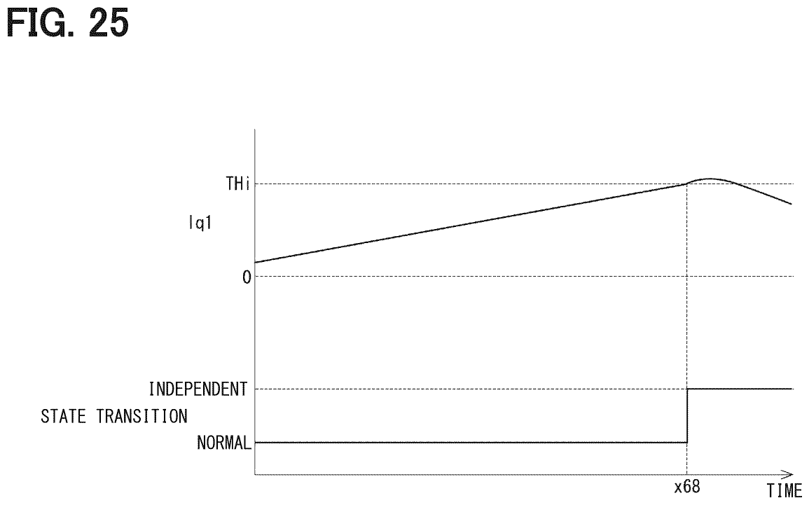

The fifth embodiment is shown in FIGS. 24 and 25. The fifth to tenth embodiments will focus on the abnormality handling process, and will be explained mainly using the first system L1 as an example. When the q-axis current detection value Iq1 of the first system L1 increases in the positive direction and the q-axis current detection value Iq2 of the second system L2 increases in the negative direction, the addition of the two is equal to zero, which may look like no high electric current flowing therein (see FIG. 19). On the other hand, when the balance is lost, high electric currents may surface, possibly leading to failure of a control target.

Therefore, in the present embodiment, when an abnormality occurs in the current detection value in one or more of the systems, the abnormality handling process is performed. The abnormality determination process in the present embodiment is explained based on the flowchart in FIG. 24 and the time chart in FIG. 25. As shown in FIG. 24, in S401, the abnormality determination unit 560 acquires the current detection values Id1, Iq1, Id2, and Iq2 for each system.

In S402, the abnormality determination unit 560 determines whether the current detection values Id1, Iq1, Id2, and Iq2 of each of the two systems are smaller than a current abnormality determination threshold value THi. Here, the determination is made based on absolute values. The current abnormality determination threshold value THi may be equal or different for the value pertaining to the d-axis and the value pertaining to the q-axis. When it is determined that the current detection values Id1, Iq1, Id2, and Iq2 of each of the two systems are smaller than the current abnormality determination threshold value THi (S402: YES), the process proceeds to S403, and continues the coordinated drive control normally in the two systems. When it is determined that at least one of the current detection values Id1, Iq1, Id2, and Iq2 of each of the two systems is equal to or greater than the current abnormality determination threshold value THi (S402: NO), the process proceeds to S404 for the abnormality handling process. In case of performing the abnormality handling process, warning lamps or other warnings are used by the warning unit 565 to provide a warning. The same applies to the implementation of abnormality handling process in the embodiments described below.

In FIG. 25, the common time axis is the horizontal axis, with the detected current in the upper row and the state transition in the lower row. Here, the q-axis current detection value Iq1 is shown as an example of the detected current. When the q-axis current detection value Iq1 exceeds the current abnormality determination threshold value THi at time x68, the coordinated drive control of the two systems shifts to the independent drive control as the abnormality handling process. Instead of shifting to independent drive control, the abnormality handling process may be performed as (a) shifting to the single system drive control, which stops the system in which the abnormality of electric current is detected, or (b) stop of an assist. Further, as an abnormality handling process, the voltage instruction value, which is the value calculated based on the current FB calculation result, may be limited to prevent overcurrent from occurring while continuing the coordinated drive control of the two systems.

Further, in S402, instead of performing determination by the current detection value, the d-axis current sum Id_a or the q-axis current sum Iq_a may be used for determination. Furthermore, the abnormality handling process may be performed when the voltage instruction values Vd* and Vq* exceed a voltage abnormality determination threshold value THv. Also, the electric current instruction value and the voltage instruction value are not limited to the dq-axis values, but the 3-phase values may be used for abnormality determination.

When the current detection value or the sum of the current detection values of multiple systems is greater than the current abnormality determination threshold value THi, the control units 151 and 251 limit the voltage instruction value or stop the coordinated drive control. Stop of the coordinated drive control includes transition to the independent drive control, transition to the single system drive control, and stop of assist.

Further, when the voltage instruction value is greater than the voltage abnormality determination threshold value THv, the control unit 151 and 251 may limit the voltage instruction value or stop the coordinated drive control. The electric current in the motor windings 180 and 280 is directly reducible by limiting the voltage instruction value or by stopping the assist. In addition, shifting to the independent drive control or to the single system drive control can prevent the overcurrent due to deviation of the electric current instruction value among the two systems.

The control units 151 and 251 include the warning units 565 and 665 to warn the driver when limiting the voltage instruction value or when stopping the coordinated drive control. In such manner, the driver is appropriately informed that the control is different from the coordinated drive control normally performed by the two systems. The fifth embodiment also provides the same advantages as the above-described embodiment.

### Sixth Embodiment

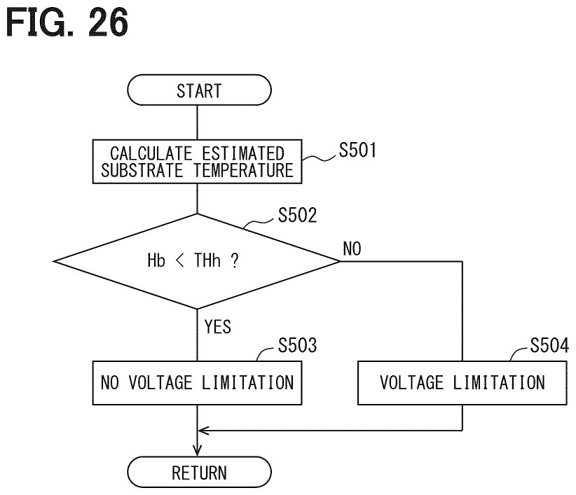

The sixth embodiment is shown in FIG. 26. In the present embodiment, when a substrate temperature abnormality is detected, the abnormality handling process is performed. The present embodiment of abnormality determination process is explained based on the flowchart in FIG. 26.

In S501, the control unit 151 calculates an estimated substrate temperature Hb based on the detection value of the temperature sensor not shown. In S502, the abnormality determination unit 560 determines whether the estimated substrate temperature Hb is lower than an overheat determination threshold value THh. When it is determined that the estimated substrate temperature Hb is lower than the overheat determination threshold value THh (S502: YES), the process proceeds to S503. When it is determined that the estimated substrate temperature Hb is equal to or higher than the overheat determination threshold value THh (S502: NO), the process proceeds to S504.

In S503, the current control calculation unit 530 does not perform voltage limiting and outputs the voltage instruction value calculated based on the electric current instruction value as it is. In S504, the current control calculation unit 530 limits the voltage instruction values Vq1* and Vd1* to voltage limit values Vq_lim and Vd_lim as the abnormality handling process.

For example, when a temperature estimation calculation cycle is longer than a current FB control calculation cycle, such as when the current FB calculation cycle is 200 [μs] and the temperature estimation calculation cycle is 80 [ms], the calculation load can be reduced compared to a case where voltage limiting is performed using parameters related to the current FB control. In addition, by limiting the voltage instruction value calculated based on the current FB control calculation result as overheat protection, abnormal currents that cannot be stopped by limiting the electric current instruction value, such as inter-system instruction deviation, for example, are preventable. Note that, as the abnormality handling process, shifting to the independent drive control, shifting to the single system drive control, or stopping the assist may also be an option.

In the present embodiment, when the estimated substrate temperature Hb, which is the temperature of the substrate 20 on which the inverter circuits 120 and 220 are mounted for switching the energization of the motor windings 180 and 280, is higher than the overheat determination threshold value THh, the voltage instruction value is limited or the coordinated drive control is stopped. Since the drive voltage is lowered by limiting the voltage instruction value, which is the instruction value after the current FB control, the overheating of the inverter circuits 120, 220, and the like can be more appropriately suppressed. The sixth embodiment also provides the same advantages as the above-described embodiment.

### Seventh Embodiment

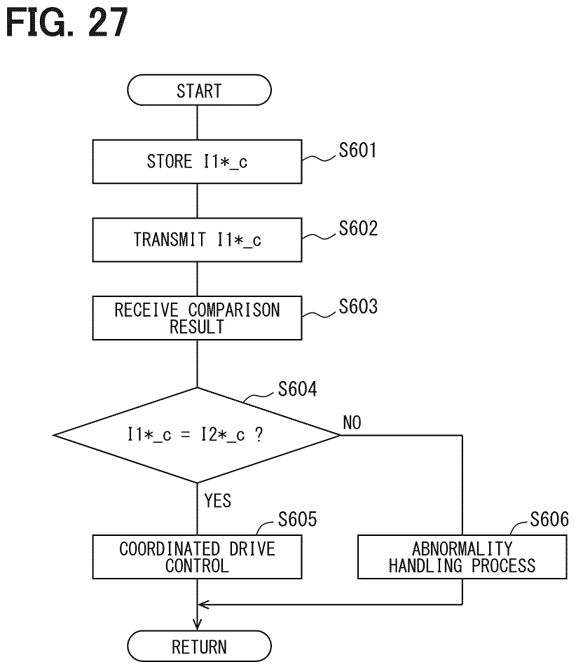

The seventh embodiment is shown in FIGS. 27 through 30. As explained in FIG. 7 and elsewhere, when the electric current instruction values are different among the control units 151 and 251, abnormal currents may be generated. Therefore, in the present embodiment, when the electric current instruction values used for the current FB control are different, the abnormality handling process is performed.

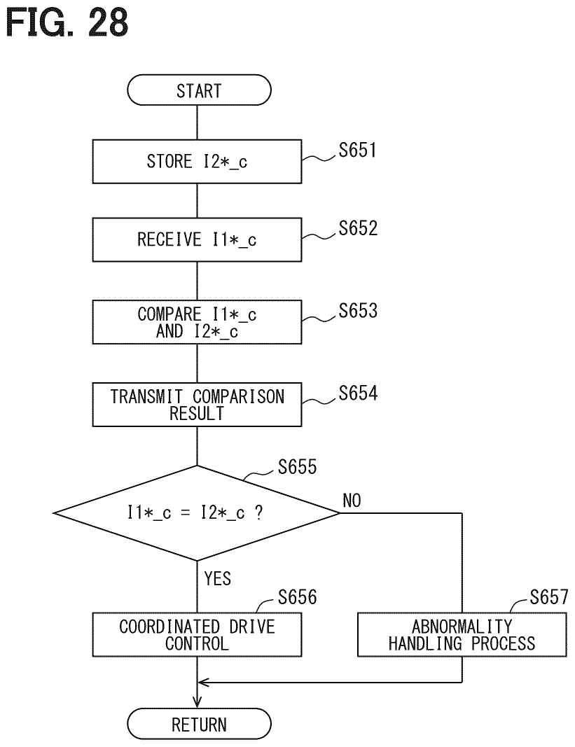

An instruction value comparison process of the first control unit 151, which is considered as a main system in the present embodiment, is shown in FIG. 27, and the instruction value comparison process of the second control unit 251, which is considered as sub, is shown in FIG. 28. This process is performed when the coordinated drive control with shared instruction values is being performed. As shown in FIG. 27, in S601, the first control unit 151 stores the electric current instruction value I1* used in the current FB control calculation in the transmission unit 171 as a value for comparison. Hereafter, the instruction values used for comparison are I1*_c and I2*_c.

In S602, the first control unit 151 transmits the electric current instruction value I1*_c for comparison to the second control unit 251. In S603, the first control unit 151 receives a comparison result from the second control unit 251.

In S604, the abnormality determination unit 560 determines whether the electric current instruction values I1*_c and I2*_c for comparison are identical based on the comparison results acquired from the second control unit 251. When it is determined that the electric current instruction values I1*_c and I2*_c for comparison match (S604: YES), the process proceeds to S605 to continue the coordinated drive control normally in the two systems. When it is determined that the electric current instruction values I1*_c and I2*_c for comparison do not match (S604: NO), the process proceeds to S606 for performing the abnormality handling process.

As shown in FIG. 28, in S651, the second control unit 251 stores the electric current instruction value I2* used in the current FB control calculation in a memory unit not shown for comparison. The value stored here is I2*_c. When the coordinated drive control is being performed, the value received from the first control unit 151 by inter-microcontroller communication is stored as the electric current instruction value I2*_c for comparison.

In S652, the second control unit 251 receives the electric current instruction value I1*_c for comparison from the first control unit 151 by inter-microcontroller communication. In S653, the second control unit 251 compares the electric current instruction values I1*_c and I2*_c for comparison. In S654, the second control unit 251 transmits the comparison results of the electric current instruction values I1*_c and I2*_c for comparison back to the first control unit 151 by inter-microcontroller communication. The process of S655 to S657 is similar to the process of S604 to S606 in FIG. 27.

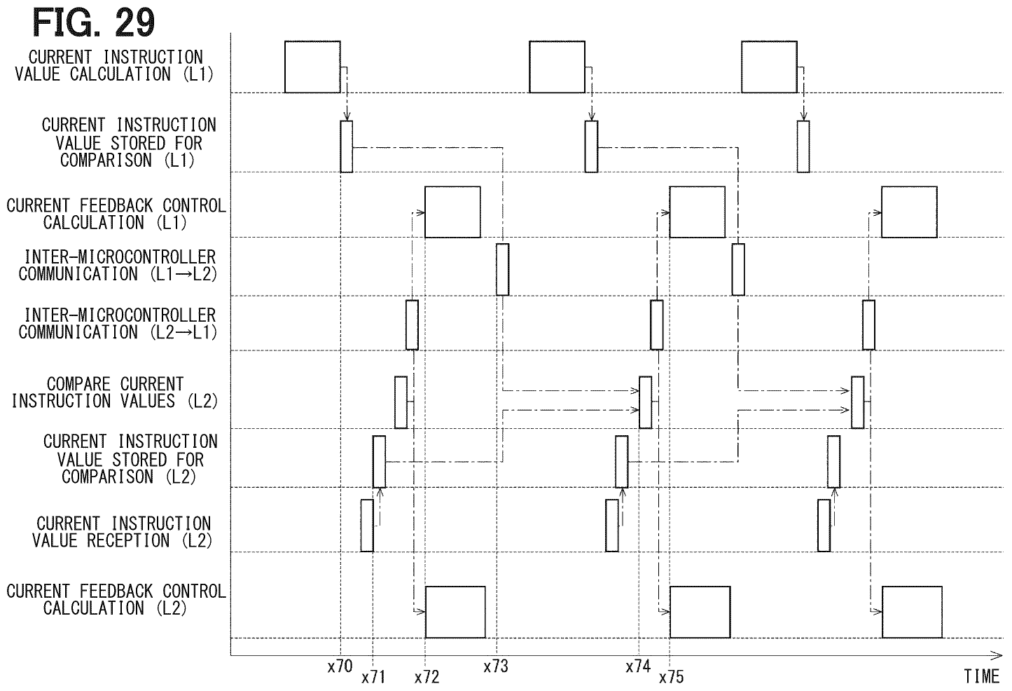

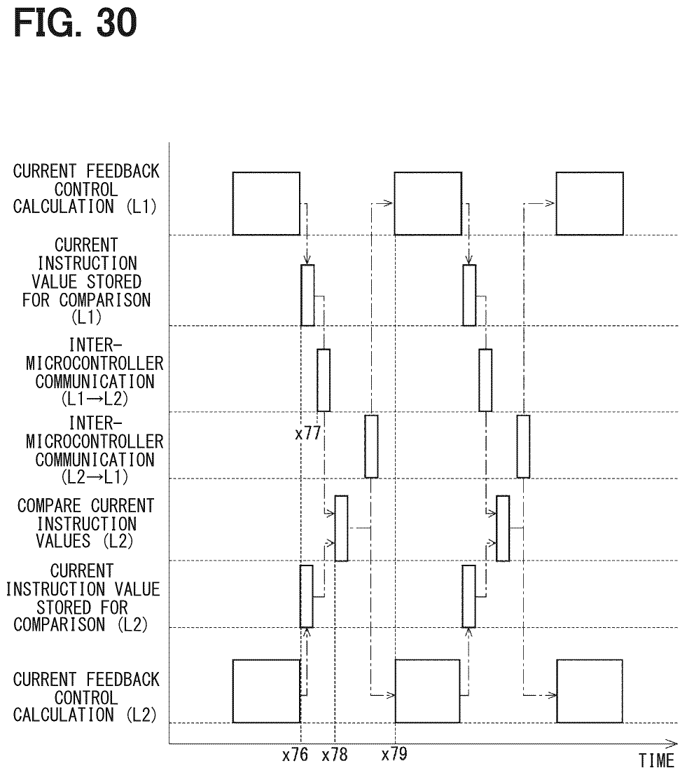

The instruction value comparison process in the present embodiment is explained based on the time charts in FIGS. 29 and 30. FIG. 29 shows an example where the torque electric current instruction value Itrq1* is used for comparison, and FIG. 30 shows an example where the instruction values used in the current control calculation unit 530, for example, the q-axis electric current instruction values Iq1* and Iq2*, are used for comparison. The d-axis electric current instruction value may be used instead of the q-axis electric current instruction value. The same applies to the ninth embodiment. In FIGS. 29 and 30, the focus of explanation is put on the processes related to data for comparison, thereby omitting explanations of data transmission, reception and the like used for the current FB calculations.

As shown in FIG. 29, at time x70, the first control unit 151 stores the torque electric current instruction value Itrq1* in the transmission unit 171 as the electric current instruction value I1*_c for comparison. At time x71, the second control unit 251 stores the torque electric current instruction value received from the first control unit 151 in the reception unit 272 as the electric current instruction value I2*_c for comparison. Data may be stored in a memory area other than the reception unit 272. The electric current instruction values I1*_c and I2*_c for comparison are the values used for the current FB control calculation at time x72.

At time x73 after the current FB control calculation, the first control unit 151 transmits the electric current instruction value I1*_c for comparison, which is the electric current instruction value used in the previous current FB calculation, to the second control unit 251 by inter-microcontroller communication. At time x74, the second control unit 251 compares the electric current instruction values I1*_c and I2*_c used in the previous current FB control calculation, and transmits the comparison results back to the first control unit 151 by inter-microcontroller communication.

In the current FB control calculation at time x75, a process is performed according to the instruction value comparison result used for the previous calculation. That is, when the electric current instruction values I1*_c and I2*_c used in the previous current FB control calculation match, the coordinated drive control of the two systems is normally performed, and when the values do not match, the abnormality handling process is performed.

As shown in FIG. 30, at time x76, the first control unit 151 stores the q-axis electric current instruction value Iq1* used in the current FB control calculation in the transmission unit 171 as the electric current instruction value I1*_c for comparison. The second control unit 251 stores the q-axis electric current instruction value Iq2* used in the current FB control calculation as the electric current instruction value I2*_c for comparison in a memory unit not shown.

At time x77, the first control unit 151 transmits the electric current instruction value I1*_c for comparison to the second control unit 251 by inter-microcontroller communication. At time x78, the second control unit 251 compares the electric current instruction values I1*_c and I2*_c for comparison, and transmits the comparison results back to the first control unit 151 by inter-microcontroller communication. The current FB control calculation at time x79 is the same as the one at time x75 in FIG. 29.

In the explanation of the present embodiment, the electric current instruction value I1*_c for comparison is transmitted from the first control unit 151 to the second control unit 251, and instruction value comparison is performed in the second control unit 251. Alternatively, (A) the second control unit 251 may transmit values for comparison to the first control unit 151, and the first control unit 151 may perform instruction value comparisons, or (B) values for comparison may be exchanged between the first control unit 151 and the second control unit 251, and the comparison of the instruction values may be performed on both of the first control unit 151 and the second control unit 251.

In the examples in FIGS. 29 and 30, comparison of the instruction values between systems are performed for every cycle of the electric current instruction value or every cycle of the current FB control calculation (e.g., 200 [μs]). However, the comparison cycle may be different from the calculation cycle of the electric current instruction values, that is, for example, the comparison cycle may be a cycle of every 800 [μs] or the like. When the comparison cycle is different from the calculation cycle, the values at the comparison timing may be used as representative values for comparison, or all values may be transmitted and compared individually. Further, for example, a comparison may be made with an arithmetic value (e.g., additive value) using multiple values calculated during the comparison cycle. Also, the comparison may also be performed by calculating values for inspection, such as CRC signals, and the like. The same applies to each of the parameters used for comparison in the embodiments described below.

The control units 151 and 251 compare the previous instruction values of their own systems, that is, compare (a) the instruction value used in the previous current control calculation in one system and (b) the instruction value used in the previous current control calculation in the other system. When the previous instruction value of the own system is different from that of the other system, the voltage instruction value is limited, or the coordinated drive control is stopped. In such manner, deviation among the electric current instruction values for a long period of time is preventable, thereby preventing overcurrent due to deviation among the instruction values. The seventh embodiment also achieves the same advantages as the embodiments described above.

### Eighth Embodiment

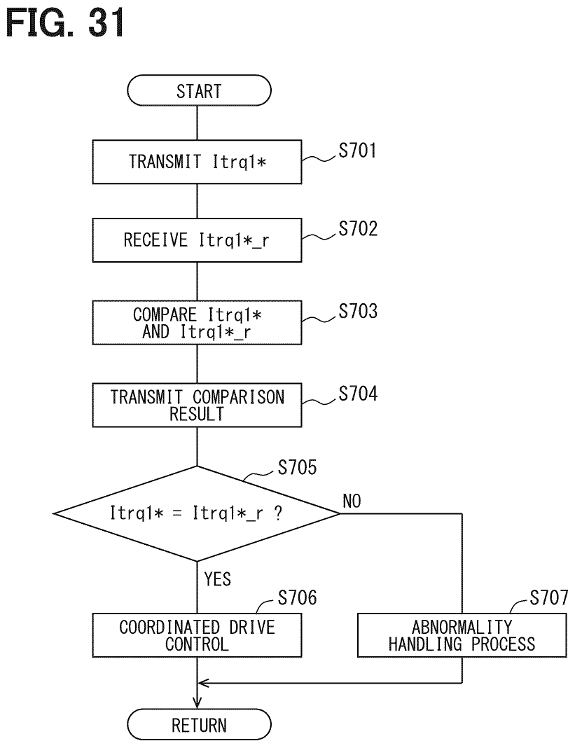

The eighth embodiment is shown in FIGS. 31 through 33. In the eighth embodiment, whether or not to perform the abnormality handling process is determined by comparing the instruction values of the previous calculation. In the eighth and ninth embodiments, the electric current instruction values are compared to determine whether or not the abnormality handling process is performed.

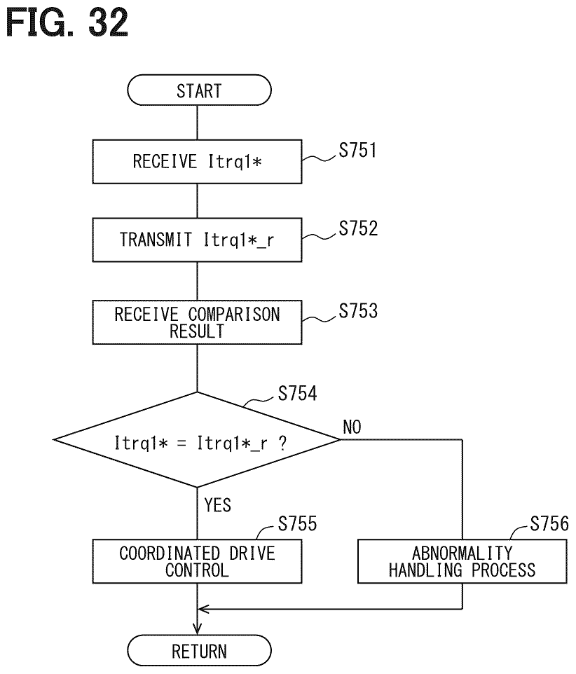

The process on a control unit 151 side is shown in FIG. 31, and the process on a control unit 251 side is shown in FIG. 32. As shown in FIG. 31, in S701, the first control unit 151 transmits the torque electric current instruction value Itrq1* to the second control unit 251. In S702, the first control unit 151 receives a returned value Itrq1*_r, which is the torque electric current instruction value transmitted back from the second control unit 251.

In S703, the first control unit 151 compares the returned value Itrq1*_r with the value calculated by the torque current instruction calculation unit 513. Here, the value calculated by the torque current instruction calculation unit 513 and used for comparison with the return value Itrq1*_r is referred to as a “first system calculation value.” In S704, the first control unit 151 transmits the comparison results to the second control unit 251.

In S705, the first control unit 151 determines whether the return value Itrq1*_r and the first system calculation value match. When it is determined that the returned value Itrq1*_r and the first system calculation value match (S705: YES), the process proceeds to S706 to continue the coordinated drive control normally in the two systems. When it is determined that the returned value Itrq1*_r and the first system calculation value do not match (S705: NO), the process proceeds to S707, in which the abnormality handling process is performed.

As shown in FIG. 32, in S751, the second control unit 251 receives the torque electric current instruction value Itrq1* by inter-microcontroller communication. In S752, the second control unit 251 transmits the value received in S751 as the returned value Itrq1*_r back to the first control unit 151 by inter-microcontroller communication. In S753, the second control unit 251 receives the comparison result from the first control unit 151 by inter-microcontroller communication.

In S754, the second control unit 251 determines whether the return value Itrq1*_r matches the first system calculation value based on the comparison results acquired from the first control unit 151. The details of S754 to S756 are the same as S705 to S707 in FIG. 31.

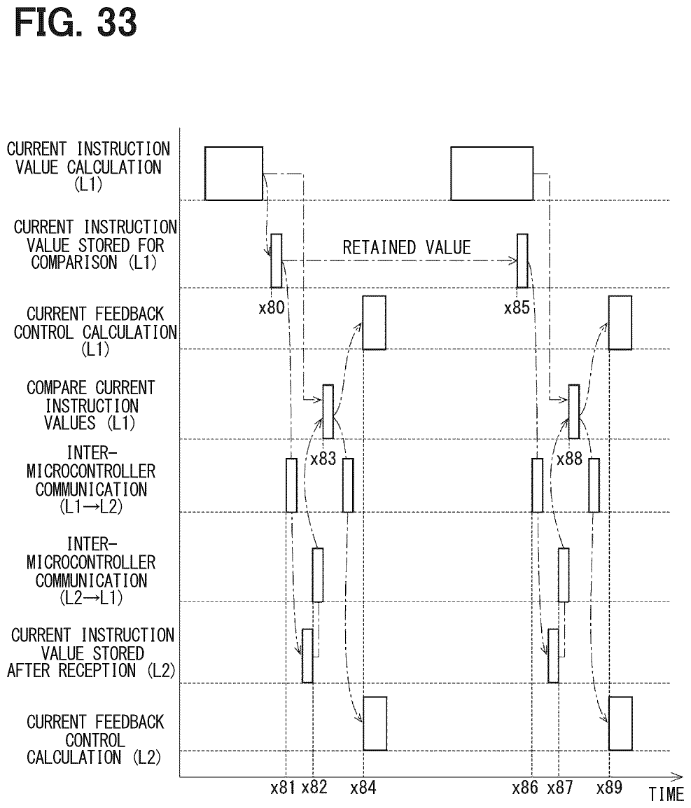

The instruction value comparison process in the present embodiment is explained based on the time chart in FIG. 33. At time x80, the first control unit 151 stores the torque electric current instruction value Itrq1* calculated by the torque current instruction calculation unit 513 in the transmission unit 171. At time x81, the first control unit 151 transmits the torque electric current instruction value Itrq1* to the second control unit 251, which stores the received value in the reception unit 272.

At time x82, the second control unit 251 transmits back to the first control unit 151 the torque electric current instruction value Itrq1* received from the first control unit 151. At time x83, the first control unit 151 compares the returned value Itrq1*_r transmitted back from the second control unit 251 with the first system calculation value, and transmits the comparison results to the second control unit 251 by inter-microcontroller communication. At time x84, a process according to the comparison results is performed. In this cycle of calculation, there is no delay in the calculation of the torque electric current instruction value Itrq1*, and the returned value Itrq1*_r and the first system calculation value are identical, thereby the coordinated drive control of the two systems is performed.

At time x85, which is the data storage timing for the next inter-microcontroller communication, the previous value is retained because the electric current instruction value calculation has not been complete. At time x86, the previous value is transmitted from the first control unit 151 to the second control unit 251 by inter-microcontroller communication, and at time x87, the value is returned from the second control unit 251 back to the first control unit 151 by inter-microcontroller communication.

At time x88, the first control unit 151 compares the return value Itrq1*_r with the first system calculation value, and transmits the comparison results to the second control unit 251 by inter-microcontroller communication. In such case, though the calculation of the electric current instruction value Itrq1* was not complete in time for the data storage timing of the inter-microcontroller communication at time x85, the calculation of the electric current instruction value Itrq1* was complete at the comparison timing of time x88. Therefore, when the value of the electric current instruction value Itrq1* has changed from the value in the previous cycle, the comparison results at time x88 will not show matching of the values. Therefore, at time x89, the abnormality handling process is performed.

The second control unit 251 transmits, back to the first control unit 151, the electric current instruction value transmitted from the first control unit 151, compares the returned value Itrq1*_r, which is the electric current instruction value transmitted back from the second control unit 251, with the electric current instruction value of its own system in the first control unit 151, and limits the voltage instruction value when the values are different from each other, or stops the coordinated drive control. In such manner, a shift to the abnormality handling process is performable according to the comparison results, in which the current values are compared. The eighth embodiment also achieves the same advantages as the embodiments described above.

### Ninth Embodiment

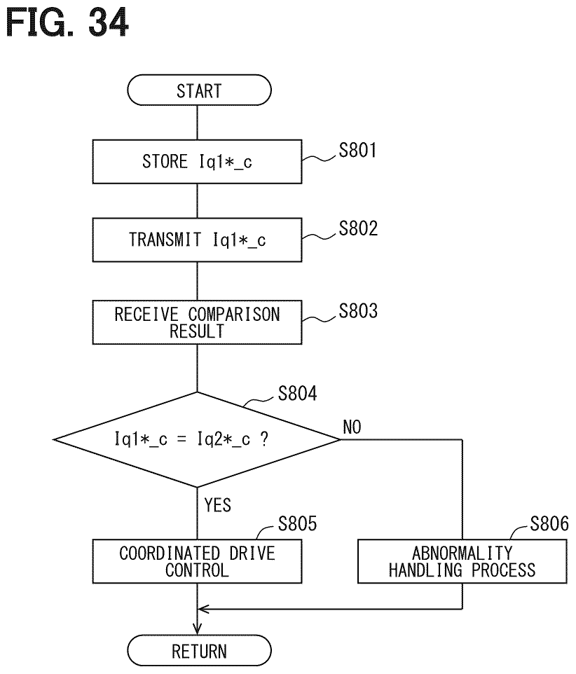

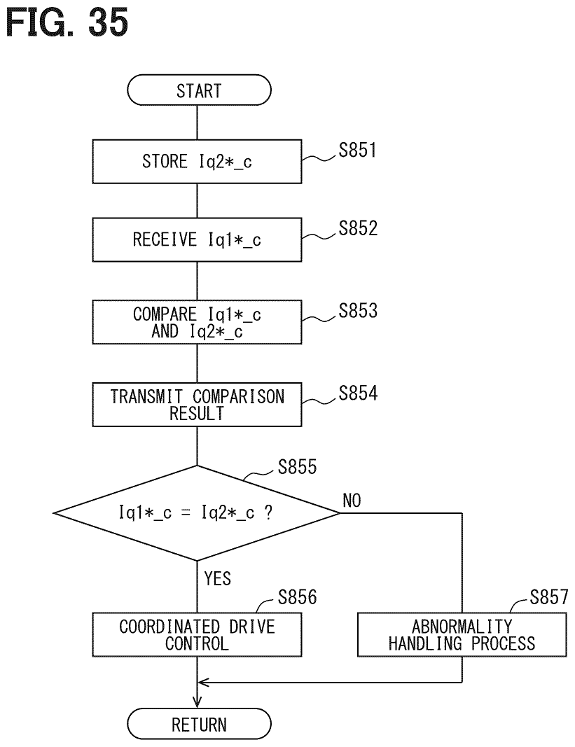

The ninth embodiment is shown in FIGS. 34 through 36. The process on a control unit 151 side is shown in FIG. 34, and the process on a control unit 251 side is shown in FIG. 35. As shown in FIG. 34, in S801, the first control unit 151 stores the q-axis electric current instruction value Iq1* in the transmission unit 171 as the q-axis electric current instruction value Iq1*_c for comparison. In S802, the first control unit 151 transmits the q-axis electric current instruction value Iq1*_c for comparison to the second control unit 251. In S803, the first control unit 151 receives the comparison results from the second control unit 251.

In S804, the first control unit 151 determines whether the q-axis electric current instruction values Iq1*_c and Iq2*_c for comparison match. When it is determined that the q-axis electric current instruction values Iq1*_c and Iq2*_c for comparison match (S804: YES), the process proceeds to S805 for performing the coordinated drive control normally in the two systems. When it is determined that the q-axis electric current instruction values Iq1*_c and Iq2*_c for comparison do not match (S804: NO), the process proceeds to S806 for performing the abnormality handling process.

As shown in FIG. 35, in S851, the second control unit 251 stores the q-axis electric current instruction value Iq2* calculated based on the torque electric current instruction value Itrq1* acquired from the first control unit 151 in a process separate from the current process for comparison in a memory unit not shown. The value stored here is designated as Iq2*_c.

In S852, the second control unit 251 receives the q-axis electric current instruction value Iq1*_c for comparison from the first control unit 151 by inter-microcontroller communication. In S853, the second control unit 251 compares the q-axis electric current instruction values Iq1*_c and Iq2*_c for comparison. In S854, the second control unit 251 transmits the comparison results to the first control unit 151. The process of S855 to S857 is similar to the process of S805 to S807 in FIG. 34.

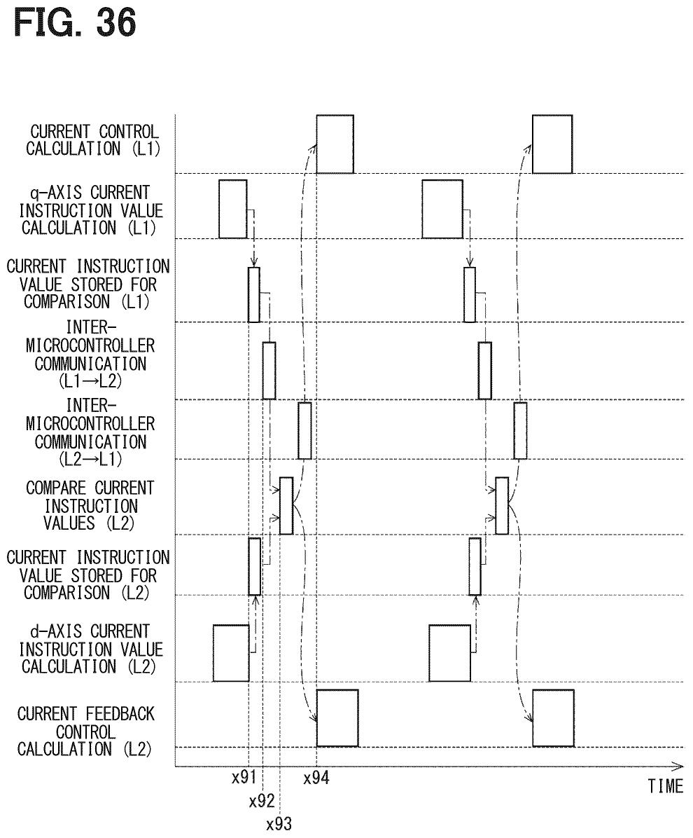

The instruction value comparison process in the present embodiment is explained based on the time chart in FIG. 36. At time x91, the first control unit 151 stores the q-axis electric current instruction value Iq1* in the transmission unit 171 as the q-axis electric current instruction value Iq1*_c for comparison. The second control unit 251 stores the q-axis electric current instruction value Iq2* as the electric current instruction value Iq2*_c for comparison in a memory unit not shown.

At time x92, the first control unit 151 transmits the q-axis electric current instruction value Iq1*_c for comparison to the second control unit 252. At time x93, the second control unit 251 compares the q-axis electric current instruction values Iq1*_c and Iq2*_c for comparison, and transmits the comparison results back to the first control unit 151 by inter-microcontroller communication. At time x94, a process is performed according to the comparison results. In other words, when the q-axis electric current instruction values Iq1*_c and Iq2*_c for comparison match, the coordinated drive control is performed normally in the two systems, and when they do not match, the abnormality handling process is performed.

In the present embodiment, the control units 151 and 251 compare (a) the d-axis electric current instruction values Id* and Iq*, which are calculated based on the torque electric current instruction value Itrq* and used for the current FB control, with (b) the values pertaining to the other system before current FB control calculation, and when at least one of the dq-axis electric current instruction values Id* and Iq* is different from that of the other system, the voltage instruction value is limited or the coordinated drive control is stopped. As in the eighth embodiment, a shift to the abnormality handling process is performable according to the comparison results of the current values described above. The ninth embodiment also achieves the same advantages as the embodiments described above.

### Tenth Embodiment

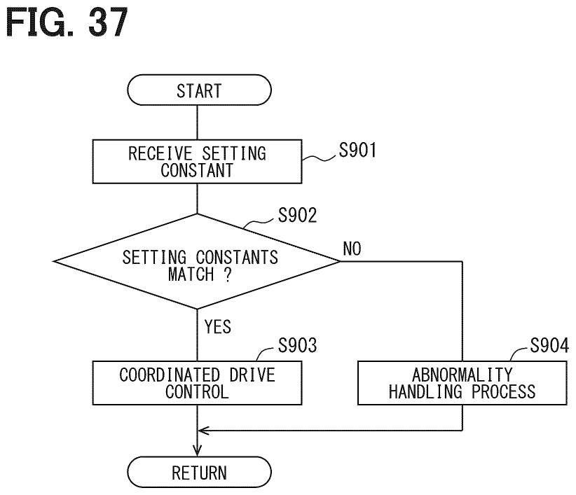

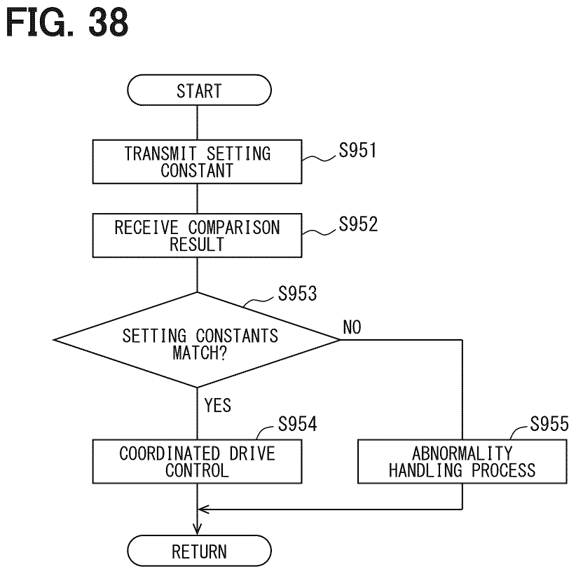

The tenth embodiment is described based on FIGS. 37 and 38. In the third embodiment, the first control unit 151 possesses a setting constant, and the second control unit 251 acquires the setting constant from the first control unit 151 by inter-microcontroller communication and uses it. In the present embodiment, both of the first control unit 151 and the second control unit 251 have their own setting constants.

The setting constant comparison process on the main side is shown in FIG. 37, and the setting constant comparison process on the sub side is shown in FIG. 38. This process is performed, for example, during the initial check. The process in FIG. 38 may be performed on the sub side and the process in FIG. 37 may be performed on the main side. As shown in FIG. 37, in S901, the first control unit 151 receives the setting constants from the second control unit 251. The setting constants transmitted and received here may be the constants themselves, or may also be arithmetic values such as addition values of multiple setting constants, values for inspection such as CRCs.

In S902, the first control unit 151 determines whether the setting constants stored in the first control unit 151 and the setting constants received from the second control unit 251 match. When it is determined that the setting constants match (S902: YES), the process proceeds to S903 for performing the coordinated drive control normally in the two systems. When it is determined that the setting constants do not match (S902: NO), the abnormality handling process is performed. Further, the determination result in S902 is transmitted to the second control unit 251.

As shown in FIG. 38, in S951, the second control unit 251 transmits the setting constants to the first control unit 151 by inter-microcontroller communication. In S952, the second control unit 251 receives the comparison results of the setting constants from the first control unit 151 by inter-microcontroller communication.

In S953, the second control unit 251 determines whether the setting constants match based on the comparison results acquired from the first control unit 151. When it is determined that the setting constants match (S953: YES), the process proceeds to S954 for performing the coordinated drive control normally in the two systems. When it is determined that the setting constants do not match (S953: NO), the process proceeds to S955 for performing the abnormality handling process.

In the present embodiment, the control units 151 and 251 limit the voltage instruction value or stop the coordinated drive control when the values of their own differ from those of the other control unit for the setting constants, which is the constant used for the control of the electric current. In such manner, deviations in calculated values due to differences in setting constants are preventable. The tenth embodiment also achieves the same advantages as the embodiments described above.

In the embodiments described above, the ECU 10 corresponds to a “rotary electric machine control device,” the motor 80 corresponds to a “rotary electric machine,” the first control unit 151 corresponds to a “main control unit,” the second control unit 251 corresponds to a “sub-control unit,” and the transmission unit 171 corresponds to a “transmission unit.”

### Other Embodiments

In the above embodiments, two control units are provided. According to the other embodiments, the number of control units may be three or more. For example, in case of a main-sub configuration, as in the first embodiment, one control unit is the main control unit and the remaining control units are sub-control units. The multiple control units do not have to be in the main-sub configuration.

In the above embodiments, in the coordinated drive control, torque electric current instruction values are transmitted from the main control unit to the sub-control unit and shared among the systems. In other embodiments, the dq-axis electric current instruction values may be transmitted from the main control unit to the sub-control unit and shared among the systems. Further, the torque instruction value before conversion to a torque electric current instruction value may also be shared. In such case, the torque instruction value can be converted to an electric current instruction value and is regarded as a “electric current instruction value.

In the above embodiments, the coordinated drive control uses sum and difference control, which controls the current sum and the current difference of the two systems. In other embodiments, coordinated drive control is not limited to the sum and difference control, as long as at least one parameter is shared among the systems. Also, the details of the current control may differ from the above embodiments. If the system consists of three or more systems, any two systems may be used for performing the sum and difference control.

In the above embodiments, two motor windings and two inverter circuits are provided. In other embodiments, there may be one or more than three motor windings and inverter circuits. Further, for example, one control unit may be provided for a plurality of motor windings and a plurality of inverter circuits, or a plurality of inverter circuits and a plurality of motor windings may be provided for one control unit. That is, the numbers of the motor windings, inverter circuits and control units may be respectively different.

In the above embodiments, the rotary electric machine is a three-phase brushless motor. In other embodiment, the rotary electric machine is not limited to the brushless motor. The rotary electric machine may also be a so-called motor generator that also has the function of a generator. In the above embodiments, the rotary electric machine control device is applied to an electric power steering device. In other embodiment, the rotary electric machine control device may be applied to a device such as a steer-by-wire device, which is a device other than the electric power steering device for steering control.

The control unit and the method thereof according to the present disclosure may be realized by a dedicated computer provided by configuring a processor and a memory programmed to perform one or more functions embodied by a computer program. Alternatively, the control unit and the method thereof according to the present disclosure may be realized by a dedicated computer provided by configuring a processor with one or more dedicated hardware logic circuits. Alternatively, the control unit and the method thereof according to the present disclosure may be realized by using one or more dedicated computers constituted by a combination of (a) the processor and the memory programmed to perform one or more functions and (b) the processor with one or more hardware logic circuits. The computer programs may be stored, as instructions to be executed by a computer, in a tangible, non-transitory computer-readable storage medium. The present disclosure is not limited to the above embodiments, but various modifications may be made further within the scope of the present disclosure without departing from the spirit of the disclosure.

The present disclosure has been made in accordance with the embodiments. However, the present disclosure is not limited to such embodiments and configurations. The present disclosure also encompasses various modifications and variations within the scope of equivalents. Further, various combination and formation, and other combination and formation including one, more than one or less than one element may be made in the scope of the present disclosure.

What is claimed is:

1. A rotary electric machine control device configured to control drive of a rotary electric machine including a plurality of motor windings, the rotary electric machine control device comprising:
at least one of (i) a circuit and (ii) a processor with a memory storing computer program code executable by the processor, the at least one of the circuit and the processor configured to cause the rotary electric machine control device to implement:
a plurality of control units provided for the respective motor windings and configured to communicate with each other to perform a coordinated drive control for respective systems, each of which including a combination of a motor winding and a control unit corresponding thereto, by sharing at least one parameter for performing energization control, each of the control units configured to calculate a voltage instruction value of a voltage to be applied to the motor winding based on a current detection value and an electric current instruction value of an electric current to be supplied to the motor winding and perform the energization control of the motor winding based on the voltage instruction value, wherein
one of the control units is a main control unit, and an other of the control units is a sub-control unit,
the sub-control unit is configured to perform the energization control of the motor winding by using the electric current instruction value transmitted from the main control unit, and
the main control unit is configured to perform the energization control of the motor winding by using a same electric current instruction value that has been transmitted to the sub-control unit.

2. The rotary electric machine control device of claim 1, wherein
the main control unit is configured to
store the electric current instruction value to be transmitted to the sub-control unit, and
perform the energization control of the motor winding by using the electric current instruction value as stored.

3. The rotary electric machine control device of claim 1, wherein
the main control unit is configured to
store the electric current instruction value to be transmitted to the sub-control unit, and
perform the energization control of the motor winding with a previous value retained as the electric current instruction value when the electric current instruction value as stored has not been updated.

4. The rotary electric machine control device of claim 1, wherein
the sub-control unit is configured to transmit, back to the main control unit, the electric current instruction value that has been transmitted from the main control unit, and
the main control unit is configured to
compare the electric current instruction value transmitted back from the sub-control unit with the electric current instruction value of its own system, and
limit the voltage instruction value or stop the coordinated drive control, when the electric current instruction value transmitted back from the sub-control unit is different from the electric current instruction value of its own system.

5. A rotary electric machine control device configured to control drive of a rotary electric machine including a plurality of motor windings, the rotary electric machine control device comprising:
at least one of (i) a circuit and (ii) a processor with a memory storing computer program code executable by the processor, the at least one of the circuit and the processor configured to cause the rotary electric machine control device to implement:
a plurality of control units provided for the respective motor windings and configured to communicate with each other to perform a coordinated drive control for respective systems, each of which including a combination of a motor winding and a control unit corresponding thereto, by sharing at least one parameter for performing energization control, each of the control units configured to calculate a voltage instruction value of a voltage to be applied to the motor winding based on a current detection value and an electric current instruction value of an electric current to be supplied to the motor winding and perform the energization control of the motor winding based on the voltage instruction value, wherein
the control unit is configured to
perform electric current feedback control using a current sum, which is a sum of the current detection value of its own system and the current detection value of an other system, and a current difference, which is a difference between the current detection value of its own system and the current detection value of the other system,
limit, in the electric current feedback control,
an upper limit and a lower limit of a feedback control amount, which is a result of feedback calculation based on the current sum, and
an upper limit and a lower limit of a feedback control amount, which is a result of feedback calculation based on the current difference.

6. The rotary electric machine control device of claim 5, wherein
a limit value of the current sum, which limits the upper limit and the lower limit of the feedback control amount of the current sum, and a limit value of the current difference, which limits the upper limit and the lower limit of the feedback control amount of the current difference, are equal to each other.

7. The rotary electric machine control device of claim 5, wherein
the control unit is configured to, when one of the feedback control amount of the current sum and the feedback control amount of the current difference is limited by a limit value, retain an other one of the feedback control amount of the current sum and the feedback control amount of the current difference at a previous value.

8. The rotary electric machine control device of claim 1, wherein
one of the control units is configured to transmit a setting constant, which is a constant used in an electric current control calculation, to an other one of the control units.

9. The rotary electric machine control device of claim 1, wherein
one of the control units is configured to limit the voltage instruction value or stop the coordinated drive control, when a setting constant, which is a constant used for control of an electric current, retained therein is different from the setting constant retained in an other of the control units.

10. The rotary electric machine control device of claim 1, wherein
the control unit is configured to limit the voltage instruction value or stop the coordinated drive control, when the current detection value or a sum of current detection values of the systems is greater than a current abnormality determination threshold value.

11. The rotary electric machine control device of claim 1, wherein
the control unit is configured to limit the voltage instruction value or stop the coordinated drive control, when the voltage instruction value is greater than a voltage abnormality determination threshold value.

12. The rotary electric machine control device of claim 1, wherein
the control unit is configured to limit the voltage instruction value or stop the coordinated drive control, when temperature of a substrate, on which an inverter circuit configured to switch energization of the motor windings is mounted, is higher than an overheat determination threshold value.

13. The rotary electric machine controller of claim 1, wherein
the control unit is configured to
compare a previous instruction value of its own system, which is an instruction value used for previous current control calculation in its own system, with a previous instruction value of an other system, which is an instruction value used for previous current control calculation in an other system, and
limit the voltage instruction value or stop the coordinated drive control, when the previous instruction value of its own system is different from the previous instruction value of the other system.

14. The rotary electric machine controller of claim 1, wherein
the electric current instruction value is a torque electric current instruction value calculated based on a torque instruction value, and
the control unit is configured to
compare, before performing electric current feedback control calculation, a d-axis electric current instruction value and a q-axis electric current instruction value, which are calculated based on the torque electric current instruction value and used for electric current feedback control, with the d-axis electric current instruction value and the q-axis electric current instruction value of an other system, and
limit the voltage instruction value or stop the coordinated drive control, when the d-axis electric current instruction value of its system is different from the d-axis electric current instruction value of the other system, and/or the q-axis electric current instruction value of its system is different from the q-axis electric current instruction value of the other system.

15. The rotary electric machine control device of claim 1, wherein
the control unit is configured to warn a driver when limiting the voltage instruction value or stopping the coordinated drive control.
